(19) United States
(12) Patent Application Publication
(10) Pub. No.: US 2019/0134465 A1
(43) Pub. Date: May 9, 2019

(54) GOLF BALL

(71) Applicant: SUMITOMO RUBBER INDUSTRIES, LTD., Kobe-shi (JP)

(72) Inventors: Kohei MIMURA, Kobe-shi, Hyogo (JP); Takahiro SAJIMA, Kobe-shi, Hyogo (JP)

(73) Assignee: SUMITOMO RUBBER INDUSTRIES, LTD., Kobe-shi (JP)

(21) Appl. No.: 16/163,227

(22) Filed: Oct. 17, 2018

(30) Foreign Application Priority Data
Nov. 8, 2017 (JP) 2017-215366

(51) Int. Cl. A63B 37/00

(52) U.S. Cl. CPC A63B 37/0074; A63B 37/0017; A63B 37/0018; A63B 37/0006; A63B 37/0031; A63B 37/0033; B32B 1/00; A63B 37/0083; A63B 37/0058; A63B 37/0064; A63B 37/0062; A63B 37/0094; A63B 37/0096; A63B 37/008

(57) ABSTRACT

A golf ball includes a core and a cover. The cover has a shore D hardness of not less than 50. The cover has a thickness of not less than 1.00 mm. The golf ball has a plurality of dimples 10 on a surface thereof. A standard deviation Su of areas of all the dimples 10 is not greater than 1.7 mm². A standard deviation Pd of distances L between dimples of all neighboring dimple pairs is less than 0.500 mm. A dimple pattern of each hemisphere of a phantom sphere of the golf ball includes three units (T1, T2, T3) that are rotationally symmetrical to each other. A dimple pattern of the unit T1 includes two small units (T1a, T1b) that are mirror-symmetrical to each other.

This application claims priority on Patent Application No. 2017-215366 filed in JAPAN on Nov. 8, 2017. The entire contents of this Japanese Patent Application are hereby incorporated by reference.

### BACKGROUND OF THE INVENTION

### Field of the Invention

The present invention relates to golf balls. Specifically, the present invention relates to golf balls having a core, a cover, and dimples.

### Description of the Related Art

The face of a golf club has a loft angle. When a golf ball is hit with the golf club, the golf ball is launched at a launch angle corresponding to the loft angle. Furthermore, in the golf ball, backspin due to the loft angle occurs. The golf ball flies with the backspin.

Golf balls have a large number of dimples on the surfaces thereof. The dimples disturb the air flow around the golf ball during flight to cause turbulent flow separation. This phenomenon is referred to as “turbulization”. Due to the turbulization, separation points of the air from the golf ball shift backwards leading to a reduction of drag. The turbulization promotes the displacement between the separation point on the upper side and the separation point on the lower side of the golf ball, which results from the backspin, thereby enhancing the lift force that acts upon the golf ball. The reduction of drag and the enhancement of lift force are referred to as a “dimple effect”. Excellent dimples efficiently disturb the air flow. The excellent dimples produce a long flight distance. There have been various proposals for dimples.

JP50-8630 discloses a golf ball having a large number of dimple pairs each having a distance of less than 0.065 inches between a dimple and another dimple adjacent to this dimple. In the golf ball, a large number of dimples are densely arranged.

JP2008-389 discloses a golf ball having dimple pairs each having an interval that is sufficiently small when being compared to the average diameter of dimples. In the golf ball, a large number of dimples are densely arranged.

JP2013-153966 discloses a golf ball in which a large number of dimples are densely arranged and the sizes of the dimples are less varied. A similar golf ball is also disclosed in JP2015-24079.

In light of flight performance, there have also been proposals for materials and structures of golf balls.

JP2008-194471 discloses a golf ball in which the materials and the hardnesses of a core, a mid layer, and a cover are modified.

There have also been proposals for matching between dimples and structures of golf balls. JP2008-212666 discloses a golf ball having non-circular dimples and having a predetermined amount of compressive deformation.

The greatest interest to golf players concerning golf balls is flight distance. In particular, normal amateur golf players place importance on flight distances upon shots with drivers. The head speeds of the amateur golf players are generally low.

An object of the present invention is to provide a golf ball having excellent flight performance upon a shot with a driver having a low head speed.

### SUMMARY OF THE INVENTION

A golf ball according to the present invention includes a core and a cover positioned outside the core. The cover has a shore D hardness of not less than 50. The cover has a thickness of not less than 1.00 mm. The golf ball has a plurality of dimples on a surface thereof. A standard deviation Su of areas of all the dimples is not greater than 1.7 mm². A standard deviation Pd of distances L between dimples of all neighboring dimple pairs is less than 0.500 mm.

When the golf ball according to the present invention is hit with a driver, the golf ball is launched at a high launch angle with a low spin rate. Furthermore, when the golf ball is hit with a driver having a low head speed, the flight distance after the peak of a trajectory is long. The golf ball has excellent flight performance upon a shot with a driver having a low head speed.

A ratio So of a sum of areas of the dimples relative to a surface area of a phantom sphere is preferably not less than 78.0%.

The standard deviation Su is preferably not greater than 1.62 mm². The standard deviation Pd is preferably not greater than 0.458 mm.

A dimple pattern of each hemisphere of a phantom sphere of the golf ball preferably includes three units that are rotationally symmetrical to each other. A dimple pattern of each unit includes two small units that are mirror-symmetrical to each other.

A sum of volumes of all the dimples is preferably not less than 450 mm³ and not greater than 750 mm³. A total number of the dimples is preferably not less than 250 and not greater than 390.

The Shore D hardness of the cover is preferably not less than 53. The thickness of the cover is preferably not greater than 1.80 mm.

### BRIEF DESCRIPTION OF THE DRAWINGS

FIG. 1 is a schematic cross-sectional view of a golf ball according to an embodiment of the present invention;

FIG. 2 is an enlarged plan view of the golf ball in FIG. 1;

FIG. 3 is a front view of the golf ball in FIG. 2;

FIG. 4 is a partially enlarged cross-sectional view of the golf ball in FIG. 1;

FIG. 5 is a partially enlarged view of the golf ball in FIGS. 2 and 3;

FIG. 6 is an explanatory diagram for the definition of neighboring dimples in the golf ball in FIGS. 2 and 3;

FIG. 7 is an explanatory diagram for the definition of neighboring dimples in the golf ball in FIGS. 2 and 3;

FIG. 8 is an explanatory diagram for the definition of neighboring dimples in the golf ball in FIGS. 2 and 3;

FIG. 9 is an explanatory diagram for the definition of neighboring dimples in the golf ball in FIGS. 2 and 3;

FIG. 10 is a schematic cross-sectional view of a golf ball according to another embodiment of the present invention;

FIG. 11 is a plan view of a golf ball according to Example 2 of the present invention;

FIG. 12 is a front view of the golf ball in FIG. 11;

FIG. 13 is a plan view of a golf ball according to Example 3 of the present invention;

FIG. 14 is a front view of the golf ball in FIG. 13;

FIG. 15 is a plan view of a golf ball according to Example 4 of the present invention;

FIG. 16 is a front view of the golf ball in FIG. 15;

FIG. 17 is a plan view of a golf ball according to Comparative Example 1;

FIG. 18 is a front view of the golf ball in FIG. 17;

FIG. 19 is a plan view of a golf ball according to Comparative Example 2;

FIG. 20 is a front view of the golf ball in FIG. 19;

FIG. 21 is a plan view of a golf ball according to Example 5; and

FIG. 22 is a front view of the golf ball in FIG. 21.

### DESCRIPTION OF THE PREFERRED EMBODIMENTS

The following will describe in detail the present invention based on preferred embodiments with appropriate reference to the drawings.

### First Embodiment

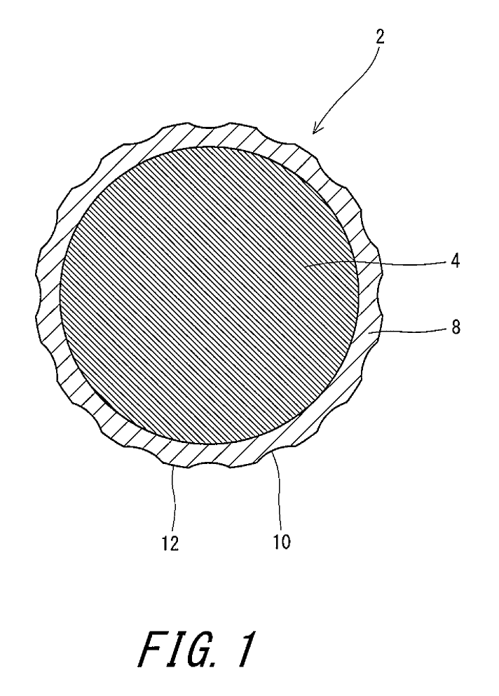

A golf ball 2 shown in FIG. 1 includes a spherical core 4 and a cover 8 positioned outside the core 4. In this embodiment, the cover 8 is directly joined to the core 4. The golf ball 2 is a so-called two-piece ball. The golf ball 2 has a plurality of dimples 10 on the surface thereof. Of the surface of the golf ball 2, a part other than the dimples 10 is a land 12. The golf ball 2 includes a paint layer and a mark layer on the external side of the cover 8, although these layers are not shown in the drawing.

The golf ball 2 preferably has a diameter of not less than 40 mm and not greater than 45 mm. From the viewpoint of conformity to the rules established by the United States Golf Association (USGA), the diameter is particularly preferably not less than 42.67 mm. In light of suppression of air resistance, the diameter is more preferably not greater than 44 mm and particularly preferably not greater than 42.80 mm. The golf ball 2 preferably has a weight of not less than 40 g and not greater than 50 g. In light of attainment of great inertia, the weight is more preferably not less than 44 g and particularly preferably not less than 45.00 g. From the viewpoint of conformity to the rules established by the USGA, the weight is particularly preferably not greater than 45.93 g.

The core 4 is formed by crosslinking a rubber composition. Examples of preferable base rubbers for use in the rubber composition include polybutadienes, polyisoprenes, styrene-butadiene copolymers, ethylene-propylene-diene copolymers, and natural rubbers. In light of flight distance upon a shot with a driver having a low head speed, polybutadienes are preferable. When a polybutadiene and another rubber are used in combination, it is preferred if the polybutadiene is a principal component. Specifically, the proportion of the polybutadiene to the entire base rubber is preferably not less than 50% by weight and particularly preferably not less than 80% by weight. A polybutadiene in which the proportion of cis-1,4 bonds is not less than 80% is particularly preferable.

The rubber composition of the core 4 preferably includes a co-crosslinking agent. Preferable co-crosslinking agents in light of durability and resilience performance of the golf ball 2 are monovalent or bivalent metal salts of an α,β-unsaturated carboxylic acid having 2 to 8 carbon atoms. Examples of preferable co-crosslinking agents include zinc acrylate, magnesium acrylate, zinc methacrylate, and magnesium methacrylate. In light of durability and resilience performance of the golf ball 2, zinc acrylate and zinc methacrylate are particularly preferable.

The rubber composition may include a metal oxide and an α,β-unsaturated carboxylic acid having 2 to 8 carbon atoms. They both react with each other in the rubber composition to obtain a salt. The salt serves as a co-crosslinking agent. Examples of preferable α,β-unsaturated carboxylic acids include acrylic acid and methacrylic acid. Examples of preferable metal oxides include zinc oxide and magnesium oxide.

The amount of the co-crosslinking agent per 100 parts by weight of the base rubber is preferably not less than 10 parts by weight. The amount of deformation of the core 4 in which this amount is not less than 10 parts by weight is not excessively large when the golf ball 2 is hit. In the golf ball 2 including the core 4, the cover 8 is less likely to break. The golf ball 2 including the core 4 also has excellent resilience performance. From these viewpoints, this amount is more preferably not less than 15 parts by weight and particularly preferably not less than 20 parts by weight.

The amount of the co-crosslinking agent per 100 parts by weight of the base rubber is preferably not greater than 45 parts by weight. The core 4 in which this amount is not greater than 45 parts by weight sufficiently deforms when the golf ball 2 is hit. The core 4 can achieve soft feel at impact for the golf ball 2. From this viewpoint, this amount is more preferably not greater than 40 parts by weight and particularly preferably not greater than 35 parts by weight.

Preferably, the rubber composition of the core 4 includes an organic peroxide. The organic peroxide serves as a crosslinking initiator. The organic peroxide contributes to the durability and the resilience performance of the golf ball 2. Examples of suitable organic peroxides include dicumyl peroxide, 1,1-bis(t-butylperoxy)-3,3,5-trimethylcyclohexane, 2,5-dimethyl-2,5-di(t-butylperoxy)hexane, and di-t-butyl peroxide. An organic peroxide with particularly high versatility is dicumyl peroxide.

The amount of the organic peroxide per 100 parts by weight of the base rubber is preferably not less than 0.1 parts by weight. The amount of deformation of the core 4 in which this amount is not less than 0.1 parts by weight is not excessively large when the golf ball 2 is hit. In the golf ball 2 including the core 4, the cover 8 is less likely to break. The golf ball 2 including the core 4 also has excellent resilience performance. From these viewpoints, this amount is more preferably not less than 0.3 parts by weight and particularly preferably not less than 0.5 parts by weight.

The amount of the organic peroxide per 100 parts by weight of the base rubber is preferably not greater than 3.0 parts by weight. The core 4 in which this amount is not greater than 3.0 parts by weight sufficiently deforms when the golf ball 2 is hit. The core 4 can achieve soft feel at impact for the golf ball 2. From this viewpoint, this amount is more preferably not greater than 2.5 parts by weight and particularly preferably not greater than 2.0 parts by weight.

Preferably, the rubber composition of the core 4 includes an organic sulfur compound. The organic sulfur compound contributes to a flight distance upon a shot with a driver having a low head speed. Organic sulfur compounds include naphthalenethiol compounds, benzenethiol compounds, and disulfide compounds.

Examples of naphthalenethiol compounds include 1-naphthalenethiol, 2-naphthalenethiol, 4-chloro-1-naphthalenethiol, 4-bromo-1-naphthalenethiol, l-chloro-2-naphthalenethiol, l-bromo-2-naphthalenethiol, l-fluoro-2-naphthalenethiol, l-cyano-2-naphthalenethiol, and 1-acetyl-2-naphthalenethiol.

Examples of benzenethiol compounds include benzenethiol, 4-chlorobenzenethiol, 3-chlorobenzenethiol, 4-bromobenzenethiol, 3-bromobenzenethiol, 4-fluorobenzenethiol, 4-iodobenzenethiol, 2,5-dichlorobenzenethiol, 3,5-dichlorobenzenethiol, 2,6-dichlorobenzenethiol, 2,5-dibromobenzenethiol, 3,5-dibromobenzenethiol, 2-chloro-5-bromobenzenethiol, 2,4,6-trichlorobenzenethiol, 2,3,4,5,6-pentachlorobenzenethiol, 2,3,4,5,6-pentafluorobenzenethiol, 4-cyanobenzenethiol, 2-cyanobenzenethiol, 4-nitrobenzenethiol, and 2-nitrobenzenethiol.

Examples of disulfide compounds include diphenyl disulfide, bis(4-chlorophenyl)disulfide, bis(3-chlorophenyl)disulfide, bis(4-bromophenyl)disulfide, bis(3-bromophenyl)disulfide, bis(4-fluorophenyl)disulfide, bis(4-iodophenyl)disulfide, bis(4-cyanophenyl)disulfide, bis(2,5-dichlorophenyl)disulfide, bis(3,5-dichlorophenyl)disulfide, bis(2,6-dichlorophenyl)disulfide, bis(2,5-dibromophenyl)disulfide, bis(3,5-dibromophenyl)disulfide, bis(2-chloro-5-bromophenyl)disulfide, bis(2-cyano-5-bromophenyl)disulfide, bis(2,4,6-trichlorophenyl)disulfide, bis(2-cyano-4-chloro-6-bromophenyl)disulfide, bis(2,3,5,6-tetrachlorophenyl)disulfide, bis(2,3,4,5,6-pentachlorophenyl)disulfide, and bis(2,3,4,5,6-pentabromophenyl)disulfide.

In light of flight distance upon a shot with a driver having a low head speed, the amount of the organic sulfur compound per 100 parts by weight of the base rubber is preferably not less than 0.1 parts by weight, more preferably not less than 0.2 parts by weight, and particularly preferably not less than 0.3 parts by weight. In light of soft feel at impact, the amount is preferably not greater than 1.5 parts by weight, more preferably not greater than 1.0 parts by weight, and particularly preferably not greater than 0.8 parts by weight. Two or more organic sulfur compounds may be used in combination.

The rubber composition of the core 4 may include a filler for the purpose of specific gravity adjustment and the like. Examples of suitable fillers include zinc oxide, barium sulfate, calcium carbonate, and magnesium carbonate. The amount of the filler is determined as appropriate so that the intended specific gravity of the core 4 is accomplished. The rubber composition may include various additives, such as sulfur, a carboxylic acid, a carboxylate, an anti-aging agent, a coloring agent, a plasticizer, a dispersant, and the like, in an adequate amount. The rubber composition may include crosslinked rubber powder or synthetic resin powder.

The core 4 preferably has a diameter of not less than 39.0 mm. In the golf ball 2 that includes the core 4 having a diameter of not less than 39.0 mm, the cover 8 is thin. Therefore, the golf ball 2 has excellent feel at impact. Furthermore, the golf ball 2 has excellent resilience performance. From these viewpoints, the diameter is more preferably not less than 39.5 mm and particularly preferably not less than 39.8 mm. In light of durability of the golf ball 2, the diameter is preferably not greater than 41.0 mm, more preferably not greater than 40.6 mm, and particularly preferably not greater than 40.3 mm.

The golf ball 2 satisfies the following mathematical formula.

Hs−Ho≥10

In this mathematical formula, Ho represents a hardness at the central point of the core 4, and Hs represents a hardness at the surface of the core 4. The core 4 that satisfies the above mathematical formula has a so-called outer-hard/inner-soft structure. When the golf ball 2 including the core 4 is hit with a driver, spin is suppressed. When the golf ball 2 including the core 4 is hit with a driver, a high launch angle is obtained.

Upon a shot with a driver, an appropriate trajectory height and appropriate flight duration are required. With the golf ball 2 that achieves a desired trajectory height and desired flight duration at a high spin rate, the run after landing is short. With the golf ball 2 that achieves a desired trajectory height and desired flight duration at a high launch angle, the run after landing is long. In light of flight distance, the golf ball 2 that achieves a desired trajectory height and desired flight duration at a high launch angle is preferable. The core 4 having an outer-hard/inner-soft structure can contribute to a high launch angle and a low spin rate as described above. The golf ball 2 including the core 4 has excellent flight performance upon a shot with a driver having a low head speed.

In light of flight performance, the difference (Hs−Ho) is more preferably not less than 13 and particularly preferably not less than 15. In light of durability of the golf ball 2, the difference (Hs−Ho) is preferably not greater than 30, more preferably not greater than 27, and particularly preferably not greater than 25.

In light of durability and resilience performance, the central hardness Ho is preferably not less than 40, more preferably not less than 45, and particularly preferably not less than 50. In light of spin suppression, the hardness Ho is preferably not greater than 70, more preferably not greater than 65, and particularly preferably not greater than 60.

The hardness Ho is measured with a Shore C type hardness scale mounted to an automated hardness meter (trade name “digi test II” manufactured by Heinrich Bareiss Prufgeratebau GmbH). The hardness scale is pressed against the central point of the cross-section of a hemisphere obtained by cutting the golf ball 2. The measurement is conducted in an environment of 23° C.

In light of spin suppression, the surface hardness Hs is preferably not less than 65, more preferably not less than 68, and particularly preferably not less than 70. In light of durability of the golf ball 2, the hardness Hs is preferably not greater than 85, more preferably not greater than 82, and particularly preferably not greater than 80.

The hardness Hs is measured with a Shore C type hardness scale mounted to an automated hardness meter (trade name “digi test II” manufactured by Heinrich Bareiss Prufgeratebau GmbH). The hardness scale is pressed against the surface of the core 4. The measurement is conducted in an environment of 23° C.

The core 4 has a weight of preferably not less than 10 g and not greater than 42 g. The temperature for crosslinking the core 4 is not lower than 140° C. and not higher than 180° C. The time period for crosslinking the core 4 is not shorter than 10 minutes and not longer than 60 minutes.

The cover 8 is positioned outside the core 4. The cover 8 is the outermost layer except the mark layer and the paint layer. The cover 8 is formed from a thermoplastic resin composition. Examples of the base polymer of the resin composition include ionomer resins, thermoplastic polyester elastomers, thermoplastic polyamide elastomers, thermoplastic polyurethane elastomers, thermoplastic polyolefin elastomers, and thermoplastic polystyrene elastomers. Ionomer resins are particularly preferable. Ionomer resins are highly elastic. The golf ball 2 that includes the cover 8 including an ionomer resin has excellent resilience performance. The golf ball 2 has excellent flight distance upon a shot with a driver having a low head speed.

An ionomer resin and another resin may be used in combination. In this case, in light of resilience performance, the ionomer resin is included as the principal component of the base polymer. The proportion of the ionomer resin to the entire base polymer is preferably not less than 50% by weight, more preferably not less than 60% by weight, and particularly preferably not less than 70% by weight.

Examples of preferable ionomer resins include binary copolymers formed with an α-olefin and an α,β-unsaturated carboxylic acid having 3 to 8 carbon atoms. A preferable binary copolymer includes 80% by weight or more but 90% by weight or less of an α-olefin, and 10% by weight or more but 20% by weight or less of an α,β-unsaturated carboxylic acid. The binary copolymer has excellent resilience performance. Examples of other preferable ionomer resins include ternary copolymers formed with: an α-olefin; an α,β-unsaturated carboxylic acid having 3 to 8 carbon atoms; and an α,β-unsaturated carboxylate ester having 2 to 22 carbon atoms. A preferable ternary copolymer includes 70% by weight or more but 85% by weight or less of an α-olefin, 5% by weight or more but 30% by weight or less of an α,β-unsaturated carboxylic acid, and 1% by weight or more but 25% by weight or less of an α,β-unsaturated carboxylate ester. The ternary copolymer has excellent resilience performance. For the binary copolymer and the ternary copolymer, preferable α-olefins are ethylene and propylene, while preferable α,β-unsaturated carboxylic acids are acrylic acid and methacrylic acid. A particularly preferable ionomer resin is a copolymer formed with ethylene and acrylic acid. Another particularly preferable ionomer resin is a copolymer formed with ethylene and methacrylic acid.

In the binary copolymer and the ternary copolymer, some of the carboxyl groups are neutralized with metal ions. Examples of metal ions for use in neutralization include sodium ion, potassium ion, lithium ion, zinc ion, calcium ion, magnesium ion, aluminum ion, and neodymium ion. The neutralization may be carried out with two or more types of metal ions. Particularly suitable metal ions in light of resilience performance and durability of the golf ball 2 are sodium ion, zinc ion, lithium ion, and magnesium ion.

Specific examples of ionomer resins include trade names “Himilan 1555”, “Himilan 1557”, “Himilan 1605”, “Himilan 1706”, “Himilan 1707”, “Himilan 1856”, “Himilan 1855”, “Himilan AM7311”, “Himilan AM7315”, “Himilan AM7317”, “Himilan AM7329”, and “Himilan AM7337”, manufactured by Du Pont-MITSUI POLYCHEMICALS Co., Ltd.; trade names “Surlyn 6120”, “Surlyn 6910”, “Surlyn 7930”, “Surlyn 7940”, “Surlyn 8140”, “Surlyn 8150”, “Surlyn 8940”, “Surlyn 8945”, “Surlyn 9120”, “Surlyn 9150”, “Surlyn 9910”, “Surlyn 9945”, “Surlyn AD8546”, “HPF1000”, and “HPF2000”, manufactured by E.I. du Pont de Nemours and Company; and trade names “IOTEK 7010”, “IOTEK 7030”, “IOTEK 7510”, “IOTEK 7520”, “IOTEK 8000”, and “IOTEK 8030”, manufactured by ExxonMobil Chemical Corporation. Two or more ionomer resins may be used in combination.

The resin composition of the cover 8 may include a styrene block-containing thermoplastic elastomer. The styrene block-containing thermoplastic elastomer includes a polystyrene block as a hard segment, and a soft segment. A typical soft segment is a diene block. Examples of compounds for the diene block include butadiene, isoprene, 1,3-pentadiene, and 2,3-dimethyl-1,3-butadiene. Butadiene and isoprene are preferable. Two or more compounds may be used in combination.

Examples of styrene block-containing thermoplastic elastomers include styrene-butadiene-styrene block copolymers (SBS), styrene-isoprene-styrene block copolymers (SIS), styrene-isoprene-butadiene-styrene block copolymers (SIBS), hydrogenated SBS, hydrogenated SIS, and hydrogenated SIBS. Examples of hydrogenated SBS include styrene-ethylene-butylene-styrene block copolymers (SEBS). Examples of hydrogenated SIS include styrene-ethylene-propylene-styrene block copolymers (SEPS). Examples of hydrogenated SIBS include styrene-ethylene-ethylene-propylene-styrene block copolymers (SEEPS).

In light of resilience performance of the golf ball 2, the content of the styrene component in the styrene block-containing thermoplastic elastomer is preferably not less than 10% by weight, more preferably not less than 12% by weight, and particularly preferably not less than 15% by weight. In light of feel at impact of the golf ball 2, the content is preferably not greater than 50% by weight, more preferably not greater than 47% by weight, and particularly preferably not greater than 45% by weight.

In the present invention, styrene block-containing thermoplastic elastomers include an alloy of an olefin and one or more members selected from the group consisting of SBS, SIS, SIBS, SEBS, SEPS, and SEEPS. The olefin component in the alloy is presumed to contribute to improvement of compatibility with another base polymer. The alloy can contribute to the resilience performance of the golf ball 2. An olefin having 2 to 10 carbon atoms is preferable. Examples of suitable olefins include ethylene, propylene, butene, and pentene. Ethylene and propylene are particularly preferable.

Specific examples of polymer alloys include trade names “RABALON T3221C”, “RABALON T3339C”, “RABALON SJ4400N”, “RABALON SJ5400N”, “RABALON SJ6400N”, “RABALON SJ7400N”, “RABALON SJ8400N”, “RABALON SJ9400N”, and “RABALON SR04”, manufactured by Mitsubishi Chemical Corporation. Other specific examples of styrene block-containing thermoplastic elastomers include trade name “Epofriend A1010” manufactured by Daicel Chemical Industries, Ltd., and trade name “SEPTON HG-252” manufactured by Kuraray Co., Ltd.

In light of feel at impact, the proportion of the styrene block-containing thermoplastic elastomer to the entire base polymer is preferably not less than 2% by weight, more preferably not less than 6% by weight, and particularly preferably not less than 10% by weight. In light of spin suppression, this proportion is preferably not greater than 40% by weight, more preferably not greater than 35% by weight, and particularly preferably not greater than 28% by weight.

The resin composition of the cover 8 may include a coloring agent, a filler, a dispersant, an antioxidant, an ultraviolet absorber, a light stabilizer, a fluorescent material, a fluorescent brightener, and the like in an adequate amount. When the hue of the golf ball 2 is white, a typical coloring agent is titanium dioxide.

The cover 8 preferably has a thickness of not less than 1.00 mm. With the golf ball 2 that includes the cover 8 having a thickness of not less than 1.00 mm, a high launch angle is obtained. Furthermore, with the golf ball 2, spin is suppressed. From these viewpoints, the thickness is more preferably not less than 1.15 mm and particularly preferably not less than 1.20 mm. In light of feel at impact, the thickness is preferably not greater than 1.80 mm, more preferably not greater than 1.60 mm, and particularly preferably not greater than 1.50 mm. The thickness is measured at a position immediately below the land 12.

The cover 8 preferably has a hardness He of not less than 50. The golf ball 2 including the cover 8 can have an outer-hard/inner-soft structure as a whole. The golf ball 2 including the cover 8 has excellent flight performance upon a shot with a driver having a low head speed. In light of flight performance, the hardness He of the cover 8 is more preferably not less than 53, further preferably not less than 55, and particularly preferably not less than 57. In light of feel at impact, the hardness He is preferably not greater than 70 and particularly preferably not greater than 65.

The hardness He of the cover 8 is measured according to the standards of “ASTM-D 2240-68”. The hardness He is measured with a Shore D type hardness scale mounted to an automated hardness meter (trade name “digi test II” manufactured by Heinrich Bareiss Prufgeratebau GmbH). For the measurement, a sheet that is formed by hot press, is formed from the same material as that of the cover 8, and has a thickness of about 2 mm is used. Prior to the measurement, a sheet is kept at 23° C. for two weeks. At the time of measurement, three sheets are stacked.

The cover 8 preferably has a Shore C hardness Hcc greater than the surface hardness Hs of the core 4. The golf ball 2 including the cover 8 can have an outer-hard/inner-soft structure as a whole. The golf ball 2 including the cover 8 has excellent flight performance upon a shot with a driver having a low head speed. In light of flight performance, the difference (Hcc-Hs) between the Shore C hardness Hcc of the cover 8 and the surface hardness Hs of the core 4 is preferably not less than 2, more preferably not less than 4, and particularly preferably not less than 5. The difference (Hcc-Hs) is preferably not greater than 30.

The Shore C hardness Hcc of the cover 8 is measured according to the standards of “ASTM-D 2240-68”. The hardness Hcc is measured with a Shore C type hardness scale mounted to an automated hardness meter (trade name “digi test II” manufactured by Heinrich Bareiss Prufgeratebau GmbH). For the measurement, a sheet that is formed by hot press, is formed from the same material as that of the cover 8, and has a thickness of about 2 mm is used. Prior to the measurement, a sheet is kept at 23° C. for two weeks. At the time of measurement, three sheets are stacked.

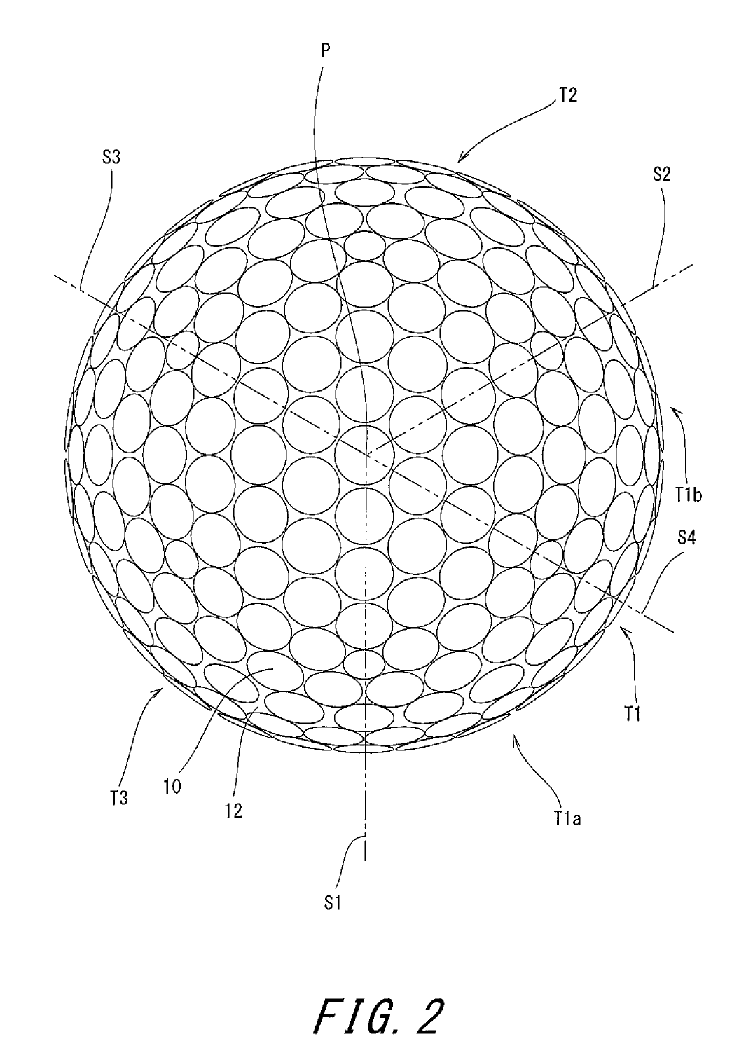

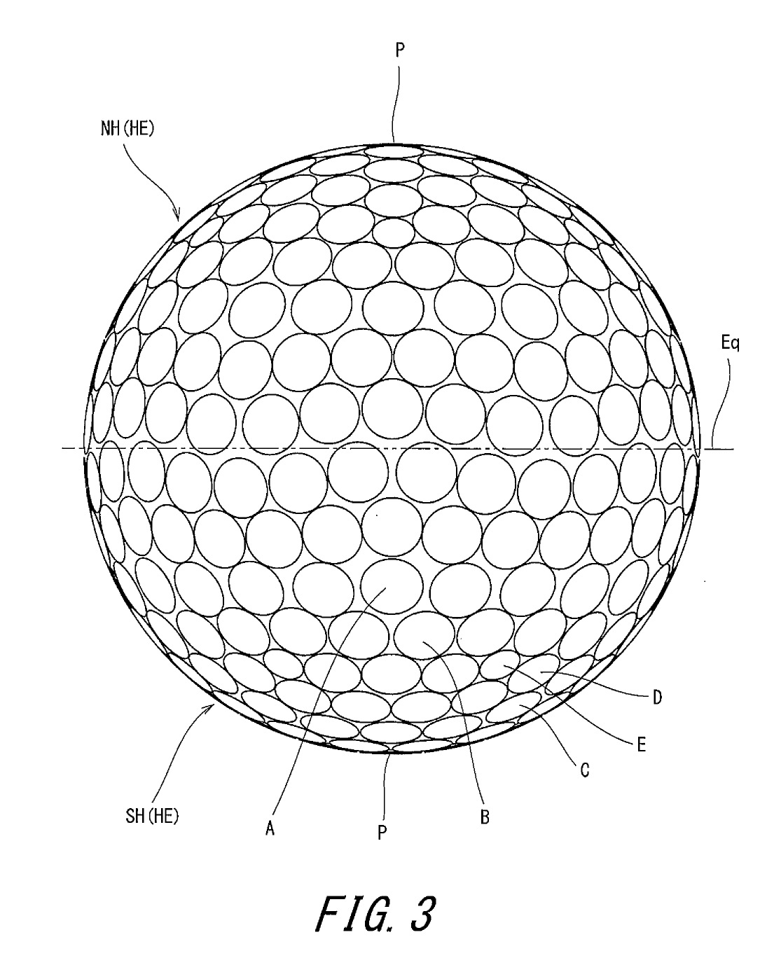

As shown in FIGS. 2 and 3, the contour of each dimple 10 is circular. The golf ball 2 has dimples A each having a diameter of 4.40 mm; dimples B each having a diameter of 4.30 mm; dimples C each having a diameter of 4.20 mm; dimples D each having a diameter of 4.10 mm; and dimples E each having a diameter of 3.00 mm. The number of types of the dimples 10 is five.

The number of the dimples A is 36; the number of the dimples B is 170; the number of the dimples C is 84; the number of the dimples D is 36; and the number of the dimples E is 12. The total number of the dimples 10 is 338. A dimple pattern is formed by these dimples 10 and the land 12.

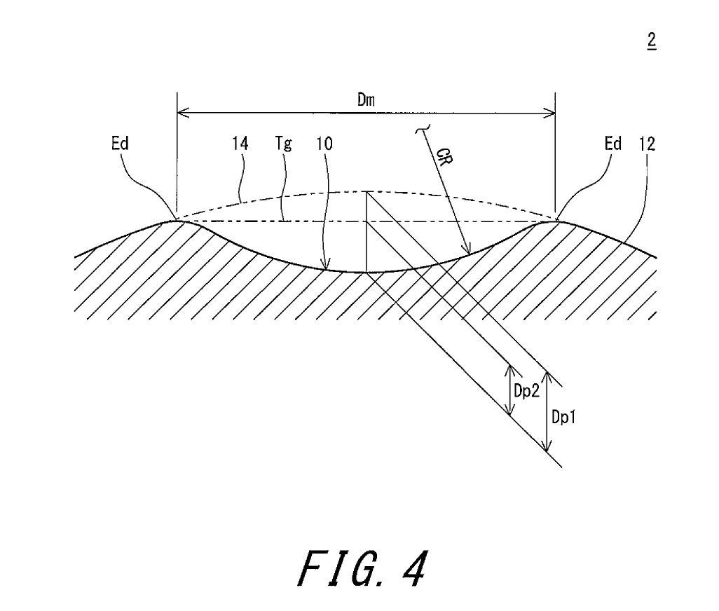

FIG. 4 shows a cross section of the golf ball 2 along a plane passing through the central point of the dimple 10 and the central point of the golf ball 2. In FIG. 4, the top-to-bottom direction is the depth direction of the dimple 10. In FIG. 4, a chain double-dashed line 14 indicates a phantom sphere 14. The surface of the phantom sphere 14 is the surface of the golf ball 2 when it is postulated that no dimple 10 exists. The diameter of the phantom sphere 14 is equal to the diameter of the golf ball 2. The dimple 10 is recessed from the surface of the phantom sphere 14. The land 12 coincides with the surface of the phantom sphere 14. In the present embodiment, the cross-sectional shape of each dimple 10 is substantially a circular arc. The curvature radius of this circular arc is shown by reference character CR in FIG. 4.

In FIG. 4, an arrow Dm indicates the diameter of the dimple 10. The diameter Dm is the distance between two tangent points Ed appearing on a tangent line Tg that is drawn tangent to the far opposite ends of the dimple 10. Each tangent point Ed is also the edge of the dimple 10. The edge Ed defines the contour of the dimple 10.

The diameter Dm of each dimple 10 is preferably not less than 2.0 mm and not greater than 6.0 mm. The dimple 10 having a diameter Dm of not less than 2.0 mm contributes to turbulization. From this viewpoint, the diameter Dm is more preferably not less than 2.5 mm and particularly preferably not less than 2.8 mm. The dimple 10 having a diameter Dm of not greater than 6.0 mm does not impair a fundamental feature of the golf ball 2 being substantially a sphere. From this viewpoint, the diameter Dm is more preferably not greater than 5.5 mm and particularly preferably not greater than 5.0 mm.

In FIG. 4, a double ended arrow Dp1 indicates a first depth of the dimple 10. The first depth Dp1 is the distance between the deepest part of the dimple 10 and the surface of the phantom sphere 14. In FIG. 4, a double ended arrow Dp2 indicates a second depth of the dimple 10. The second depth Dp2 is the distance between the deepest part of the dimple 10 and the tangent line Tg.

In light of suppression of rising of the golf ball 2 during flight, the first depth Dp1 of each dimple 10 is preferably not less than 0.10 mm, more preferably not less than 0.13 mm, and particularly preferably not less than 0.15 mm. In light of suppression of dropping of the golf ball 2 during flight, the first depth Dp1 is preferably not greater than 0.65 mm, more preferably not greater than 0.60 mm, and particularly preferably not greater than 0.55 mm.

The area S of the dimple 10 is the area of a region surrounded by the contour line of the dimple 10 when the central point of the golf ball 2 is viewed at infinity. In the case of a circular dimple 10, the area S is calculated by the following mathematical formula.

S=(Dm/2)²*π

In the golf ball 2 shown in FIGS. 2 and 3, the area of each dimple A is 15.21 mm²; the area of each dimple B is 14.52 mm²; the area of each dimple C is 13.85 mm²; the area of each dimple D is 13.20 mm²; and the area of each dimple E is 7.07 mm².

In the present invention, the ratio of the sum of the areas S of all the dimples 10 relative to the surface area of the phantom sphere 14 is referred to as an occupation ratio So. From the viewpoint of achieving sufficient turbulization, the occupation ratio So is preferably not less than 78%, more preferably not less than 80%, and particularly preferably not less than 82%. The occupation ratio So is preferably not greater than 95%. In the golf ball 2 shown in FIGS. 2 and 3, the total area of the dimples 10 is 4740.0 mm². The surface area of the phantom sphere 14 of the golf ball 2 is 5728 mm², so that the occupation ratio So is 82.8%.

The standard deviation Su of the areas of all the dimples 10 is preferably not greater than 1.70 mm². The golf ball 2 having a standard deviation Su of not greater than 1.70 mm² has excellent flight performance upon a shot with a driver having a low head speed. From this viewpoint, the standard deviation Su is more preferably not greater than 1.62 mm² and particularly preferably not greater than 1.44 mm². The standard deviation Su is preferably not less than 1.20 mm². In the present embodiment, the average of the areas of all the dimples 10 is 14.02 mm². Therefore, the standard deviation Su of the areas of these dimples is calculated by the following mathematical formula.

$$\begin{matrix}Su = & ( ( {( 15.21 - 14.02 )}^{2} * 60 + {( 14.52 - 14.02 )}^{2} * 158 + \\ & {( 13.85 - 14.02 )}^{2} * 72 + {( 13.20 - 14.02 )}^{2} * 36 + \\ & { {( 7.07 - 14.02 )}^{2} * 12 ) ) \text{/} 338 )}^{1 \text{/} 2} \\ = & 1.44\end{matrix}$$

From the viewpoint of achieving a sufficient occupation ratio So, the total number of the dimples 10 is preferably not less than 250, more preferably not less than 280, and particularly preferably not less than 300. From the viewpoint that each dimple 10 can contribute to turbulization, the total number of the dimples 10 is preferably not greater than 450, more preferably not greater than 410, and particularly preferably not greater than 390.

In the present invention, the “volume V of the dimple” means the volume of a portion surrounded by the surface of the phantom sphere 14 and the surface of the dimple 10. The total volume TV of the dimples 10 is preferably not less than 450 mm³ and not greater than 750 mm³. With the golf ball 2 having a total volume TV of not less than 450 mm³, rising of the golf ball 2 during flight is suppressed. From this viewpoint, the total volume TV is more preferably not less than 480 mm³ and particularly preferably not less than 500 mm³. With the golf ball 2 having a total volume TV of not greater than 750 mm³, dropping of the golf ball 2 during flight is suppressed. From this viewpoint, the total volume TV is more preferably not greater than 730 mm³ and particularly preferably not greater than 710 mm³.

As shown in FIG. 3, the surface of the golf ball 2 (or the phantom sphere 14) can be divided into two hemispheres HE by an equator Eq. Specifically, the surface can be divided into a northern hemisphere NH and a southern hemisphere SH. Each hemisphere HE has a pole P. The pole P corresponds to a deepest point of a mold for the golf ball 2.

The plan view in FIG. 2 shows the northern hemisphere. The southern hemisphere (corresponding to a bottom view) has a pattern obtained by rotating the dimple pattern in FIG. 2 about the pole P. Line segments S1, S2, and S3 shown in FIG. 2 each extend from the pole P. The angle at the pole P between the line segment S1 and the line segment S2 is 120°. The angle at the pole P between the line segment S2 and the line segment S3 is 120°. The angle at the pole P between the line segment S3 and the line segment S1 is 120°.

Of the surface of the golf ball 2 (or the phantom sphere 14), a zone surrounded by the line segment S1, the line segment S2, and the equator Eq (see FIG. 3) is a first spherical triangle T1. Of the surface of the golf ball 2 (or the phantom sphere 14), a zone surrounded by the line segment S2, the line segment S3, and the equator Eq is a second spherical triangle T2. Of the surface of the golf ball 2 (or the phantom sphere 14), a zone surrounded by the line segment S3, the line segment S1, and the equator Eq is a third spherical triangle T3. Each spherical triangle is a unit. The hemisphere HE can be divided into the three units.

When the dimple pattern of the first spherical triangle T1 is rotated by 120° about a straight line connecting the two poles P, the resultant dimple pattern substantially overlaps the dimple pattern of the second spherical triangle T2. When the dimple pattern of the second spherical triangle T2 is rotated by 120° about the straight line connecting the two poles P, the resultant dimple pattern substantially overlaps the dimple pattern of the third spherical triangle T3. When the dimple pattern of the third spherical triangle T3 is rotated by 120° about the straight line connecting the two poles P, the resultant dimple pattern substantially overlaps the dimple pattern of the first spherical triangle T1. In other words, the dimple pattern of the hemisphere is composed of three units that are rotationally symmetrical to each other.

A pattern obtained by rotating the dimple pattern of each hemisphere HE by 120° about the straight line connecting the two poles P substantially overlaps the dimple pattern that has not been rotated. The dimple pattern of each hemisphere HE has 120° rotational symmetry.

A line segment S4 shown in FIG. 2 extends from the pole P. The angle at the pole P between the line segment S4 and the line segment S1 is 60°. The angle at the pole P between the line segment S4 and the line segment S2 is 60°. The first spherical triangle T1 (unit) can be divided into a small spherical triangle T1a and another small spherical triangle T1b by the line segment S4. The spherical triangle T1a and the spherical triangle T1b are small units.

A pattern obtained by inverting the dimple pattern of the spherical triangle T1a with respect to a plane containing the line segment S4 and the straight line connecting both poles P substantially overlaps the dimple pattern of the spherical triangle T1b. In other words, the dimple pattern of the first spherical triangle T1 (unit) is composed of two small units that are mirror-symmetrical to each other.

Although not shown, similar to the first spherical triangle T1, the dimple pattern of the second spherical triangle T2 is also composed of two small units that are mirror-symmetrical to each other. The dimple pattern of the third spherical triangle T3 is also composed of two small units that are mirror-symmetrical to each other. The dimple pattern of the hemisphere HE is composed of the six small units.

According to the findings by the present inventor, with the golf ball 2 of which the dimple pattern of each hemisphere is composed of three units that are rotationally symmetrical to each other and the dimple pattern of each unit is composed of two small units that are mirror-symmetrical to each other, turbulization is promoted. The golf ball 2 has excellent flight performance.

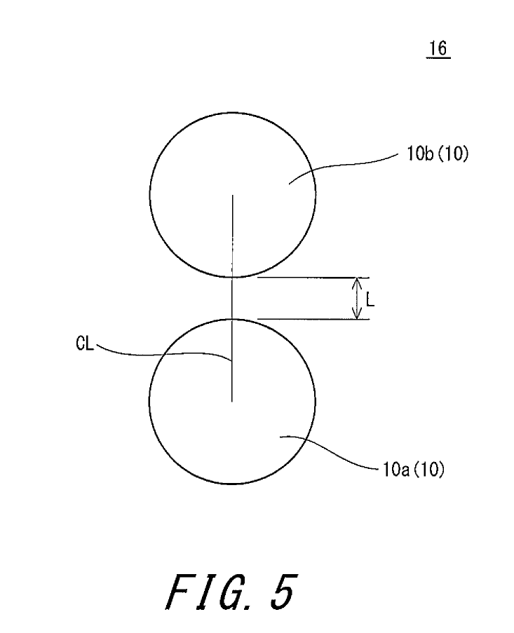

FIG. 5 is a partially enlarged view of the golf ball 2 in FIG. 2. FIG. 5 shows a first dimple 10a and a second dimple 10b. For the first dimple 10a, the second dimple 10b is a neighboring dimple. For the second dimple 10b, the first dimple 10a is a neighboring dimple. The first dimple 10a and the second dimple 10b form one neighboring dimple pair 16.

In FIG. 5, reference character CL represents the line segment that connects the center of the first dimple 10a and the center of the second dimple 10b to each other. In FIG. 5, reference character L represents the distance between the dimples 10 of the neighboring dimple pair 16. The distance L is measured along the line segment CL.

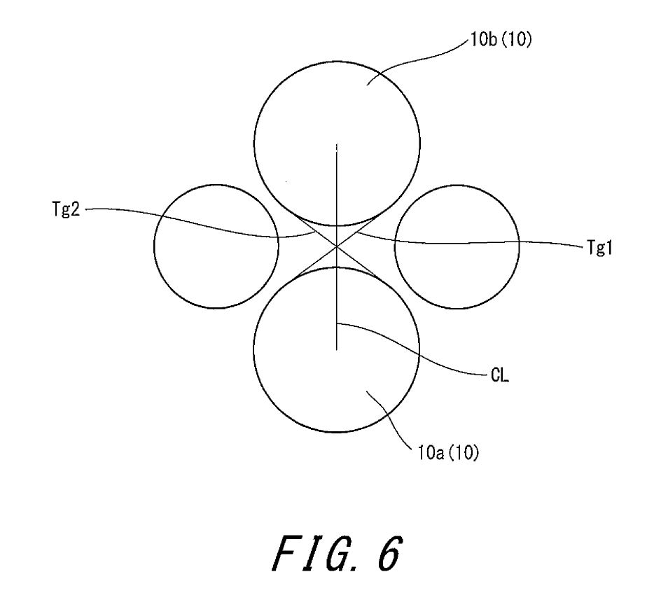

The surface of the golf ball 2 is a curved surface. The size of each dimple 10 is sufficiently small as compared to the size of the golf ball 2. Thus, in FIG. 5, the curved surface is approximated to a plane, the line segment CL is drawn, and the distance L is measured. Also in FIGS. 6 to 9 described below, similarly, the curved surface is approximated to a plane.

The following will describe the definition of neighboring dimples. FIG. 6 shows a first dimple 10a and a second dimple 10b. The line segment CL that connects the center of the first dimple 10a and the center of the second dimple 10b to each other does not intersect any dimple 10 other than the first dimple 10a and the second dimple 10b.

In FIG. 6, reference character Tg1 represents a first common inscribed line of the first dimple 10a and the second dimple 10b. The first common inscribed line Tg1 has an end on the circumference of the first dimple 10a, and another end on the circumference of the second dimple 10b. The first common inscribed line Tg1 does not intersect any dimple 10.

In FIG. 6, reference character Tg2 represents a second common inscribed line of the first dimple 10a and the second dimple 10b. The second common inscribed line Tg2 has an end on the circumference of the first dimple 10a, and another end on the circumference of the second dimple 10b. The second common inscribed line Tg2 does not intersect any dimple 10.

In the present invention, when two dimples 10 satisfy both of conditions (1) and (2) described below, these dimples 10 are referred to as a “neighboring dimple pair”.

(1) The straight line that connects the centers of these dimples to each other does not intersect any other dimple.

(2) Each of the two common inscribed lines of these dimples does not intersect any dimple.

When a neighboring dimple pair 16 is present, one dimple 10 of the neighboring dimple pair 16 is a neighboring dimple with respect to the other dimple 10, and the other dimple 10 is a neighboring dimple with respect to the one dimple 10.

The first dimple 10a and the second dimple 10b shown in FIG. 6 form a neighboring dimple pair 16. The first dimple 10a is a neighboring dimple with respect to the second dimple 10b, and the second dimple 10b is a neighboring dimple with respect to the first dimple 10a.

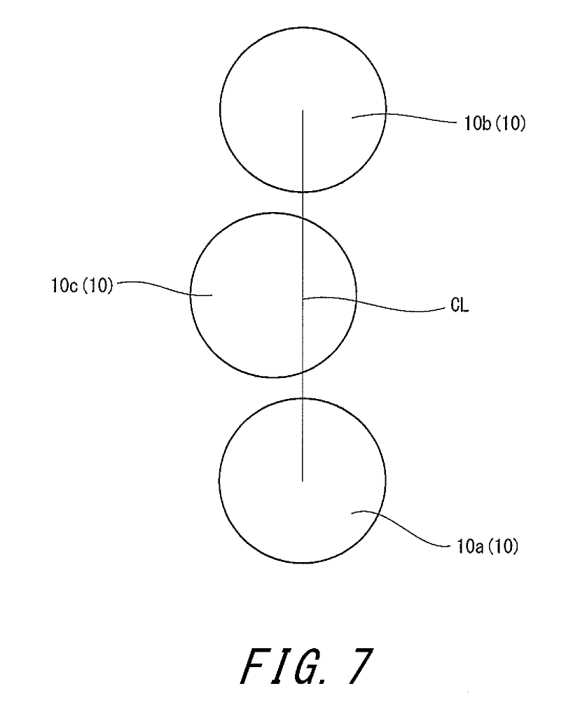

FIG. 7 shows a first dimple 10a, a second dimple 10b, and a third dimple 10c. The line segment CL that connects the center of the first dimple 10a and the center of the second dimple 10b to each other intersects the third dimple 10c. Therefore, a pair of the first dimple 10a and the second dimple 10b is not a neighboring dimple pair 16. The first dimple 10a is not a neighboring dimple with respect to the second dimple 10b, and the second dimple 10b is not a neighboring dimple with respect to the first dimple 10a.

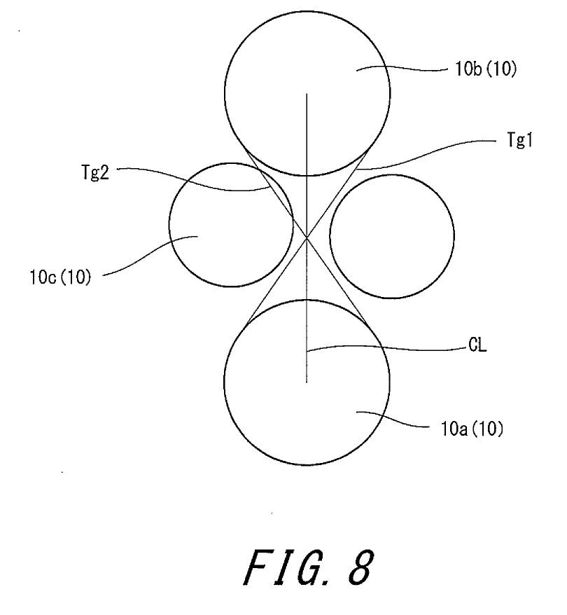

FIG. 8 shows a first dimple 10a, a second dimple 10b, and a third dimple 10c. The line segment CL that connects the center of the first dimple 10a and the center of the second dimple 10b to each other does not intersect any dimple 10 other than the first dimple 10a and the second dimple 10b. The first common inscribed line Tg1 does not intersect any dimple 10. However, the second common inscribed line Tg2 intersects the third dimple 10c. Therefore, a pair of the first dimple 10a and the second dimple 10b is not a neighboring dimple pair 16. The first dimple 10a is not a neighboring dimple with respect to the second dimple 10b, and the second dimple 10b is not a neighboring dimple with respect to the first dimple 10a.

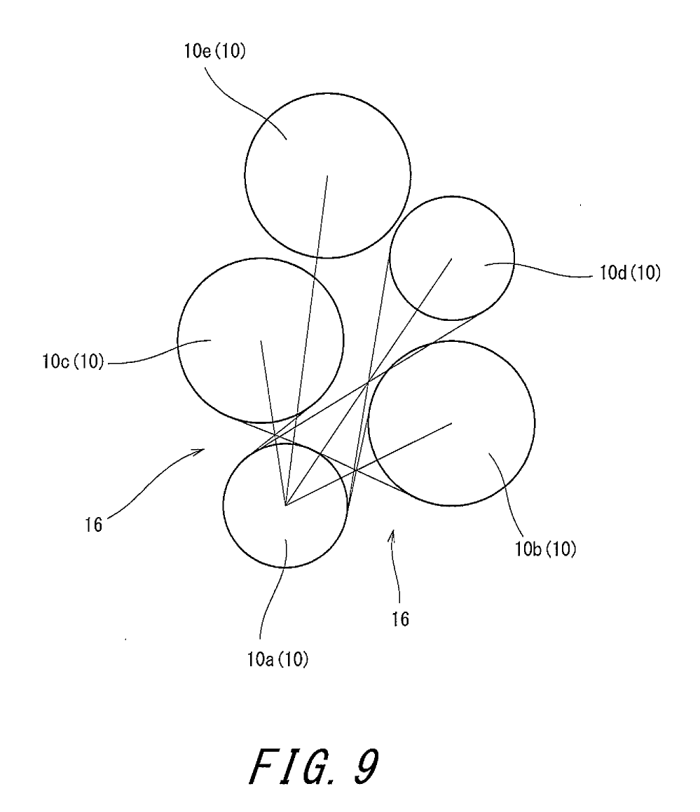

FIG. 9 shows a first dimple 10a, a second dimple 10b, a third dimple 10c, a fourth dimple 10d, and a fifth dimple 10e.

The line segment that connects the center of the first dimple 10a and the center of the second dimple 10b to each other does not intersect any dimple 10 other than the first dimple 10a and the second dimple 10b. Furthermore, each of the two common inscribed lines of the first dimple 10a and the second dimple 10b does not intersect any dimple 10. The first dimple 10a and the second dimple 10b form a neighboring dimple pair 16.

The line segment that connects the center of the first dimple 10a and the center of the third dimple 10c to each other does not intersect any dimple 10 other than the first dimple 10a and the third dimple 10c. Furthermore, each of the two common inscribed lines of the first dimple 10a and the third dimple 10c does not intersect any dimple 10. The first dimple 10a and the third dimple 10c form a neighboring dimple pair 16.

One of the two common inscribed lines of the first dimple 10a and the fourth dimple 10d intersects the second dimple 10b. Therefore, the first dimple 10a and the fourth dimple 10d do not form a neighboring dimple pair 16.

The line segment that connects the center of the first dimple 10a and the center of the fifth dimple 10e to each other intersects the third dimple 10c. Therefore, the first dimple 10a and the fifth dimple 10e do not form a neighboring dimple pair 16.

As described above, the first dimple 10a and the second dimple 10b form a neighboring dimple pair 16, and the first dimple 10a and the third dimple 10c also form a neighboring dimple pair 16. In FIG. 9, at least two neighboring dimple pairs 16 are present.

As described above, for the first dimple 10a, the second dimple 10b is a neighboring dimple, and the third dimple 10c is also a neighboring dimple. For the first dimple 10a, at least two neighboring dimples are present. Therefore, the first dimple 10a has at least two distances L (see FIG. 5). For the first dimple 10a, still another neighboring dimple may be present. In the entire golf ball 2, for each dimple 10, a neighboring dimple can be present. In the golf ball 2, a large number of neighboring dimple pairs 16 are present.

The standard deviation Pd of the distances L between the dimples 10 of all the neighboring dimple pairs 16 is preferably less than 0.500 mm. In other words, the standard deviation Pd is preferably small. As described above, in the golf ball 2, the standard deviation Su of the areas of the dimples 10 is small. In the golf ball 2 having a small standard deviation Su and a small standard deviation Pd, the dimples 10, the sizes of which are less varied, are uniformly arranged.

The vector of the lift force applied to the golf ball 2 on a trajectory after the peak has an upward vertical component and a forward horizontal component. The upward vertical component delays drop of the golf ball 2. In other words, the upward vertical component contributes to long flight duration. The forward horizontal component carries the golf ball 2 forward. With the golf ball 2 to which the lift force on a trajectory after the peak is large, a large flight distance is achieved.

According to the findings by the present inventor, with the golf ball 2 having a small standard deviation Su and a small standard deviation Pd, the lift force on a trajectory after the peak is large. In particular, upon a shot with a driver having a low head speed, the lift force is large. The golf ball 2 has excellent flight performance upon a shot with a driver having a low head speed. In light of flight performance, the standard deviation Pd is more preferably not greater than 0.458 mm and particularly preferably not greater than 0.317 mm.

The average of the distances L between the dimples 10 of all the neighboring dimple pairs 16 is preferably not greater than 1.0 mm, more preferably not greater than 0.7 mm, and particularly preferably not greater than 0.5 mm. The average is preferably not less than 0.0 mm.

### Second Embodiment

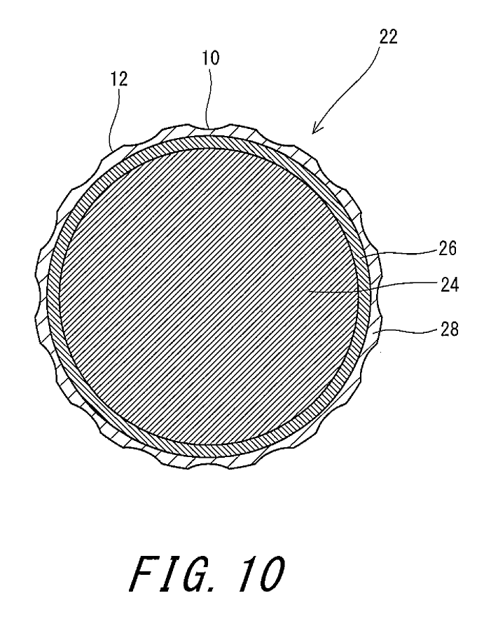

FIG. 10 is a schematic cross-sectional view of a golf ball 22 according to another embodiment of the present invention. The golf ball 22 includes a spherical core 24, a mid layer 26 positioned outside the core 24, and a cover 28 positioned outside the mid layer 26. The golf ball 22 is a so-called three-piece ball. The golf ball 22 has a plurality of dimples 10 on the surface thereof. Of the surface of the golf ball 22, a part other than the dimples 10 is a land 12. The golf ball 22 includes a paint layer and a mark layer on the external side of the cover 28, although these layers are not shown in the drawing. The golf ball 22 may include another layer between the core 24 and the mid layer 26. The golf ball 22 may include another layer between the mid layer 26 and the cover 28.

The diameter and the weight of the golf ball 22 are equal to those of the golf ball 2 shown in FIG. 1. The dimple pattern of the golf ball 22 is the same as that of the golf ball 2 shown in FIG. 1. In other words, the golf ball 22 has the dimple pattern shown in FIGS. 2 and 3. In the golf ball 22, the standard deviation Su of the areas of the dimples 10 is not greater than 1.7 mm², and the standard deviation Pd of the distances L between the dimples of all the neighboring dimple pairs is less than 0.500 mm.

The core 24 is formed by crosslinking a rubber composition. The rubber composition described above for core 4 shown in FIG. 1 can be used for the core 24.

The core 24 preferably has a diameter of not less than 38.0 mm. The golf ball 22 that includes the core 24 having a diameter of not less than 38.0 mm has excellent resilience performance. From this viewpoint, this diameter is more preferably not less than 38.5 mm and particularly preferably not less than 39.5 mm. From the viewpoint that the mid layer 26 and the cover 28 can have sufficient thicknesses, this diameter is preferably not greater than 41.0 mm and particularly preferably not greater than 40.5 mm.

In the golf ball 22, the difference (Hs−Ho) between a hardness Hs at the surface of the core 24 and a hardness Ho at the central point of the core 24 is preferably not less than 10. The core 24 has a so-called outer-hard/inner-soft structure. When the golf ball 22 including the core 24 is hit with a driver, spin is suppressed. When the golf ball 22 including the core 24 is hit with a driver, a high launch angle is obtained. In light of flight performance, the difference (Hs−Ho) is more preferably not less than 13 and particularly preferably not less than 15. In light of durability of the golf ball 22, the difference (Hs−Ho) is preferably not greater than 30, more preferably not greater than 27, and particularly preferably not greater than 25.

The mid layer 26 is positioned between the core 24 and the cover 28. The mid layer 26 is formed from a thermoplastic resin composition. Examples of the base polymer of the resin composition include ionomer resins, thermoplastic polyester elastomers, thermoplastic polyamide elastomers, thermoplastic polyurethane elastomers, thermoplastic polyolefin elastomers, and thermoplastic polystyrene elastomers. Ionomer resins are particularly preferable. Ionomer resins are highly elastic. The golf ball 22 that includes the mid layer 26 including an ionomer resin has excellent resilience performance.

An ionomer resin and another resin may be used in combination. In this case, in light of resilience performance, the ionomer resin is included as the principal component of the base polymer. The proportion of the ionomer resin to the entire base polymer is preferably not less than 30% by weight, more preferably not less than 40% by weight, and particularly preferably not less than 50% by weight. The ionomer resin described above for the cover 8 shown in FIG. 1 can be used for the mid layer 26.

The resin composition of the mid layer 26 may include a styrene block-containing thermoplastic elastomer. The styrene block-containing thermoplastic elastomer described above for the cover 8 shown in FIG. 1 can be used for the mid layer 26.

In light of feel at impact, the proportion of the styrene block-containing thermoplastic elastomer to the entire base polymer is preferably not less than 20% by weight, more preferably not less than 30% by weight, and particularly preferably not less than 40% by weight. In light of resilience performance of the golf ball 22, this proportion is preferably not greater than 70% by weight, more preferably not greater than 60% by weight, and particularly preferably not greater than 55% by weight.

The resin composition of the mid layer 26 may include a filler for the purpose of specific gravity adjustment and the like. Examples of suitable fillers include zinc oxide, barium sulfate, calcium carbonate, and magnesium carbonate. The resin composition may include powder of a metal with a high specific gravity. Specific examples of metals with a high specific gravity include tungsten and molybdenum. The amount of the filler is determined as appropriate so that the intended specific gravity of the mid layer 26 is accomplished. The resin composition may include a coloring agent, crosslinked rubber powder, or synthetic resin powder. When the hue of the golf ball 22 is white, a typical coloring agent is titanium dioxide.

The mid layer 26 preferably has a hardness Hm of not less than 20 and not greater than 60. The golf ball 22 that includes the mid layer 26 having a hardness Hm of not less than 20 has excellent resilience performance. From this viewpoint, the hardness Hm is more preferably not less than 25 and particularly preferably not less than 30. The golf ball 22 that includes the mid layer 26 having a hardness Hm of not greater than 60 has excellent feel at impact. From this viewpoint, the hardness Hm is more preferably not greater than 50 and particularly preferably not greater than 45. In the case where the golf ball 22 includes two or more mid layers 26, each mid layer 26 preferably has a hardness in the above range.

The hardness Hm is measured according to the standards of “ASTM-D 2240-68”. The hardness Hm is measured with a Shore D type hardness scale mounted to an automated hardness meter (trade name “digi test II” manufactured by Heinrich Bareiss Prufgeratebau GmbH). For the measurement, a sheet that is formed by hot press, is formed from the same material as that of the mid layer 26, and has a thickness of about 2 mm is used. Prior to the measurement, a sheet is kept at 23° C. for two weeks. At the time of measurement, three sheets are stacked.

The mid layer 26 preferably has a Shore C hardness Hmc less than the surface hardness Hs of the core 24. The golf ball 22 including the mid layer 26 has excellent flight performance upon a shot with a driver having a low head speed. In light of flight performance, the difference (Hs−Hmc) between the surface hardness Hs of the core 24 and the Shore C hardness Hmc of the mid layer 26 is preferably not less than 2, more preferably not less than 5, and particularly preferably not less than 10. The difference (Hs−Hmc) is preferably not greater than 40.

The Shore C hardness Hmc of the mid layer 26 is measured according to the standards of “ASTM-D 2240-68”. The hardness Hmc is measured with a Shore C type hardness scale mounted to an automated hardness meter (trade name “digi test II” manufactured by Heinrich Bareiss Prufgeratebau GmbH). For the measurement, a sheet that is formed by hot press, is formed from the same material as that of the mid layer 26, and has a thickness of about 2 mm is used. Prior to the measurement, a sheet is kept at 23° C. for two weeks. At the time of measurement, three sheets are stacked.

The mid layer 26 has a thickness Tm of not less than 0.3 mm and not greater than 2.5 mm. The golf ball 22 that includes the mid layer 26 having a thickness Tm of not less than 0.3 mm has excellent feel at impact. From this viewpoint, the thickness Tm is more preferably not less than 0.5 mm and particularly preferably not less than 0.8 mm. The golf ball 22 that includes the mid layer 26 having a thickness Tm of not greater than 2.5 mm has excellent resilience performance. From this viewpoint, the thickness Tm is more preferably not greater than 2.0 mm and particularly preferably not greater than 1.8 mm. The thickness Tm is measured at a position immediately below the land 12. In the case where the golf ball 22 includes two or more mid layers, each mid layer preferably has a thickness in the above range.

The cover 28 is the outermost layer except the mark layer and the paint layer. The cover 28 is formed from a resin composition. A preferable base polymer of the resin composition is an ionomer resin. The golf ball 22 that includes the cover 28 including an ionomer resin has excellent resilience performance. The ionomer resin described above for the cover 8 shown in FIG. 1 can be used for the cover 28.

An ionomer resin and another resin may be used in combination. Examples of the resin used in combination with the ionomer resin include polyurethanes, polyesters, polyamides, polyolefins, and polystyrenes. In this case, in light of resilience performance, the ionomer resin is included as the principal component of the base polymer. The proportion of the ionomer resin to the entire base polymer is preferably not less than 50% by weight, more preferably not less than 60% by weight, and particularly preferably not less than 70% by weight.

The resin composition of the cover 28 may include a coloring agent, a filler, a dispersant, an antioxidant, an ultraviolet absorber, a light stabilizer, a fluorescent material, a fluorescent brightener, and the like in an adequate amount. When the hue of the golf ball 22 is white, a typical coloring agent is titanium dioxide.

The cover 28 preferably has a thickness of not less than 1.00 mm. With the golf ball 22 that includes the cover 28 having a thickness of not less than 1.00 mm, a high launch angle is obtained. Furthermore, with the golf ball 22, spin is suppressed. From these viewpoints, the thickness is more preferably not less than 1.15 mm and particularly preferably not less than 1.20 mm. In light of feel at impact, the thickness is preferably not greater than 1.80 mm, more preferably not greater than 1.60 mm, and particularly preferably not greater than 1.50 mm. The thickness is measured at a position immediately below the land 12.

The cover 28 preferably has a hardness He of not less than 50. The golf ball 22 including the cover 28 can have an outer-hard/inner-soft structure as a whole. The golf ball 22 including the cover 28 has excellent flight performance upon a shot with a driver having a low head speed. In light of flight performance, the hardness He of the cover 28 is more preferably not less than 53, further preferably not less than 55, and particularly preferably not less than 57. In light of feel at impact, the hardness He is preferably not greater than 70 and particularly preferably not greater than 65.

The hardness He of the cover 28 is measured according to the standards of “ASTM-D 2240-68”. The hardness He is measured with a Shore D type hardness scale mounted to an automated hardness meter (trade name “digi test II” manufactured by Heinrich Bareiss Prufgeratebau GmbH). For the measurement, a sheet that is formed by hot press, is formed from the same material as that of the cover 28, and has a thickness of about 2 mm is used. Prior to the measurement, a sheet is kept at 23° C. for two weeks. At the time of measurement, three sheets are stacked.

The hardness He of the cover 28 is preferably greater than the hardness Hm of the mid layer 26. The golf ball 22 including the cover 28 can have an outer-hard/inner-soft structure as a whole. The golf ball 22 including the cover 28 has excellent flight performance upon a shot with a driver having a low head speed. In light of flight performance, the difference (Hc−Hm) between the hardness He of the cover 28 and the hardness Hm of the mid layer 26 is preferably not less than 5, more preferably not less than 10, and particularly preferably not less than 15.

### EXAMPLES

The following will show the effects of the present invention by means of Examples, but the present invention should not be construed in a limited manner on the basis of the description of these Examples.

### Example 1

A rubber composition I was obtained by kneading 100 parts by weight of a high-cis polybutadiene (trade name “BR-730”, manufactured by JSR Corporation), 31 parts by weight of zinc diacrylate, 5 parts by weight of zinc oxide, an appropriate amount of barium sulfate, 0.5 parts by weight of diphenyl disulfide, and 0.7 parts by weight of dicumyl peroxide. This rubber composition I was placed into a mold including upper and lower mold halves each having a hemispherical cavity, and heated at 170° C. for 18 minutes to obtain a core with a diameter of 40.10 mm. The amount of barium sulfate was adjusted such that a core having a predetermined weight was obtained.

A resin composition C1 was obtained by kneading 40 parts by weight of an ionomer resin (the aforementioned “Himilan AM7329”), 43 parts by weight of another ionomer resin (the aforementioned “Himilan AM7337”), 17 parts by weight of a styrene block-containing thermoplastic elastomer (the aforementioned “Rabalon T3221C”), and 6 parts by weight of titanium dioxide with a twin-screw kneading extruder. The core was placed into a final mold that includes upper and lower mold halves each having a hemispherical cavity and having a large number of pimples on its cavity face. The core was covered with the resin composition C1 by injection molding to form a cover with a thickness of 1.30 mm. Dimples having a shape that is the inverted shape of the pimples were formed on the cover.

A clear paint including a two-component curing type polyurethane as a base material was applied to this cover to obtain a golf ball of Example 1 with a diameter of about 42.7 mm and a weight of about 45.6 g. Dimple specifications D1 of this golf ball are shown in detail in Table 3 below.

### Examples 2 to 5 and Comparative Examples 1 and 2

Golf balls of Examples 2 to 5 and Comparative Examples 1 and 2 were obtained in the same manner as Example 1, except the specifications of the dimples were as shown in Tables 5 and 6 below. The specifications of the dimples are shown in detail in Tables 3 and 4 below.

### Examples 6 to 8 and Comparative Example 3

Golf balls of Examples 6 to 8 and Comparative Example 3 were obtained in the same manner as Example 1, except the composition of the cover was as shown in Table 7 below. The composition of the cover is shown in detail in Table 2 below.

### Examples 9 and 10 and Comparative Example 4

Golf balls of Examples 9 and 10 and Comparative Example 4 were obtained in the same manner as Example 1, except the thickness of the cover was as shown in Table 8 below.

### Example 11

A rubber composition I was obtained by kneading 100 parts by weight of a high-cis polybutadiene (trade name “BR-730”, manufactured by JSR Corporation), 31 parts by weight of zinc diacrylate, 5 parts by weight of zinc oxide, an appropriate amount of barium sulfate, 0.5 parts by weight of diphenyl disulfide, and 0.7 parts by weight of dicumyl peroxide. This rubber composition I was placed into a mold including upper and lower mold halves each having a hemispherical cavity, and heated at 170° C. for 18 minutes to obtain a core with a diameter of 38.70 mm. The amount of barium sulfate was adjusted such that a core having a predetermined weight was obtained.

A resin composition M1 was obtained by kneading 26 parts by weight of an ionomer resin (the aforementioned “Himilan AM7329”), 26 parts by weight of another ionomer resin (the aforementioned “Himilan AM7337”, 48 parts by weight of a styrene block-containing thermoplastic elastomer (the aforementioned “Rabalon T3221C”), and 6 parts by weight of titanium dioxide with a twin-screw kneading extruder. The core was covered with the resin composition M1 by injection molding to form a mid layer with a thickness of 1.00 mm.

A resin composition C1 was obtained by kneading 40 parts by weight of an ionomer resin (the aforementioned “Himilan AM7329”), 43 parts by weight of another ionomer resin (the aforementioned “Himilan AM7337”, 17 parts by weight of a styrene block-containing thermoplastic elastomer (the aforementioned “Rabalon T3221C”), and 6 parts by weight of titanium dioxide with a twin-screw kneading extruder. The sphere consisting of the core and the mid layer was placed into a final mold that includes upper and lower mold halves each having a hemispherical cavity and having a large number of pimples on its cavity face. The mid layer was covered with the resin composition C1 by injection molding to form a cover with a thickness of 1.00 mm. Dimples having a shape that is the inverted shape of the pimples were formed on the cover.

A clear paint including a two-component curing type polyurethane as a base material was applied to this cover to obtain a golf ball of Example 11 with a diameter of about 42.7 mm and a weight of about 45.6 g. Dimple specifications D1 of this golf ball are shown in detail in Table 3 below.

### Example 12

A golf ball of Example 12 was obtained in the same manner as Example 11, except the diameter of the core and the thickness of the cover were as shown in Table 9 below.

[Flight Test]

A driver with a head made of a titanium alloy (trade name “XXIO 9”, manufactured by DUNLOP SPORTS CO. LTD., shaft hardness: R, loft angle: 10.5°) was attached to a swing machine manufactured by Golf Laboratories, Inc. A golf ball was hit under a condition of a head speed of 40 m/sec, and the ball speed immediately after the hit, the launch angle, the spin rate, and the flight distance were measured. The flight distance is the distance from the launch point to the stop point. During the test, the weather was almost windless. The average value of data obtained by 20 measurements is shown in Tables 5 to 9 below.

TABLE 1
Composition of Core
(parts by weight)

| | I |
|---|---|
| Polybutadiene BR730 | 100 |
| Zinc diacrylate | 31 |
| Zinc oxide | 5 |
| Barium sulfate | Appropriate |
| | amount |
| Diphenyl disulfide | 0.5 |
| Dicumyl peroxide | 0.7 |
| Central point | 63 |
| (Shore C) | |
| Surface (Shore C) | 82 |

TABLE 2
Compositions of Mid Layer and Cover
(parts by weight)

| | M1 | C1 | C2 | C3 | C4 | C5 |
|---|---|---|---|---|---|---|
| Himilan | 26 | 40 | 50 | 27 | 45 | 55 |
| AM7329 | | | | | | |
| Himilan | 26 | 43 | 24 | 53 | 25 | 5 |
| AM7337 | | | | | | |
| Himilan | — | — | — | — | — | 10 |
| 1555 | | | | | | |
| NUCREL | — | — | — | — | — | 30 |
| N1050H | | | | | | |
| Rabalon | 48 | 17 | 26 | 20 | 30 | |
| T3221C | | | | | | |
| JF-90 | — | — | — | — | — | 0.2 |
| Titanium | 6 | 6 | 6 | 6 | 3 | 3 |
| dioxide | | | | | | |
| Hardness | 35 | 55 | 53 | 50 | 47 | 61 |
| (Shore D) | | | | | | |
| Hardness | 63 | 85 | 83 | 80 | 76 | 91 |
| (Shore C) | | | | | | |

TABLE 3
Specifications of Dimples

| | | | Dm | Dp2 | Dp1 | CR | S | V |
|---|---|---|---|---|---|---|---|---|
| | | Number | (mm) | (mm) | (mm) | (mm) | (mm²) | (mm³) |
| D1 | A | 36 | 4.40 | 0.135 | 0.2487 | 17.99 | 15.21 | 1.892 |
| | B | 170 | 4.30 | 0.135 | 0.2435 | 17.19 | 14.52 | 1.770 |
| | D | 84 | 4.20 | 0.135 | 0.2385 | 16.40 | 13.85 | 1.654 |
| | E | 36 | 4.10 | 0.135 | 0.2336 | 15.63 | 13.20 | 1.544 |
| | F | 12 | 3.00 | 0.135 | 0.1878 | 8.40 | 7.07 | 0.665 |
| D2 | A | 60 | 4.40 | 0.138 | 0.2517 | 17.61 | 15.21 | 1.915 |
| | B | 158 | 4.30 | 0.137 | 0.2455 | 16.94 | 14.52 | 1.785 |
| | C | 72 | 4.15 | 0.134 | 0.2351 | 16.13 | 13.53 | 1.592 |
| | D | 36 | 3.90 | 0.123 | 0.2122 | 15.52 | 11.95 | 1.269 |
| | E | 12 | 3.00 | 0.122 | 0.1748 | 9.28 | 7.07 | 0.619 |
| D3 | A | 314 | 4.20 | 0.135 | 0.2385 | 16.40 | 13.85 | 1.654 |
| | B | 12 | 3.90 | 0.135 | 0.2242 | 14.15 | 11.95 | 1.341 |
| | C | 12 | 3.00 | 0.135 | 0.1878 | 8.40 | 7.07 | 0.665 |
| D4 | A | 102 | 4.50 | 0.135 | 0.2539 | 18.82 | 15.90 | 2.021 |
| | B | 24 | 4.40 | 0.135 | 0.2487 | 17.99 | 15.21 | 1.892 |
| | C | 30 | 4.30 | 0.135 | 0.2435 | 17.19 | 14.52 | 1.770 |
| | D | 54 | 4.20 | 0.135 | 0.2385 | 16.40 | 13.85 | 1.654 |
| | E | 108 | 4.00 | 0.135 | 0.2289 | 14.88 | 12.57 | 1.440 |
| | F | 12 | 3.50 | 0.135 | 0.2068 | 11.41 | 9.62 | 0.997 |

TABLE 4
Specifications of Dimples

| | | | Dm | Dp2 | Dp1 | CR | S | V |
|---|---|---|---|---|---|---|---|---|
| | | Number | (mm) | (mm) | (mm) | (mm) | (mm²) | (mm³) |
| D5 | A | 338 | 4.11 | 0.120 | 0.2189 | 17.61 | 13.23 | 1.450 |
| D6 | A | 30 | 4.60 | 0.125 | 0.2492 | 21.22 | 16.62 | 2.073 |
| | B | 54 | 4.50 | 0.125 | 0.2439 | 20.31 | 15.90 | 1.941 |
| | C | 72 | 4.30 | 0.125 | 0.2335 | 18.55 | 14.52 | 1.697 |
| | D | 54 | 4.20 | 0.125 | 0.2285 | 17.70 | 13.85 | 1.585 |
| | E | 108 | 4.00 | 0.125 | 0.2189 | 16.06 | 12.57 | 1.377 |
| | F | 12 | 2.70 | 0.125 | 0.1677 | 7.35 | 5.73 | 0.481 |
| D7 | A | 16 | 4.60 | 0.135 | 0.2592 | 19.66 | 16.62 | 2.157 |
| | B | 30 | 4.50 | 0.135 | 0.2539 | 18.82 | 15.90 | 2.021 |
| | C | 30 | 4.40 | 0.135 | 0.2487 | 17.99 | 15.21 | 1.892 |
| | D | 150 | 4.30 | 0.135 | 0.2435 | 17.19 | 14.52 | 1.770 |
| | E | 30 | 4.20 | 0.135 | 0.2385 | 16.40 | 13.85 | 1.654 |
| | F | 66 | 4.10 | 0.135 | 0.2336 | 15.63 | 13.20 | 1.544 |
| | G | 10 | 3.80 | 0.135 | 0.2197 | 13.44 | 11.34 | 1.247 |
| | H | 12 | 3.40 | 0.135 | 0.2028 | 10.77 | 9.08 | 0.922 |

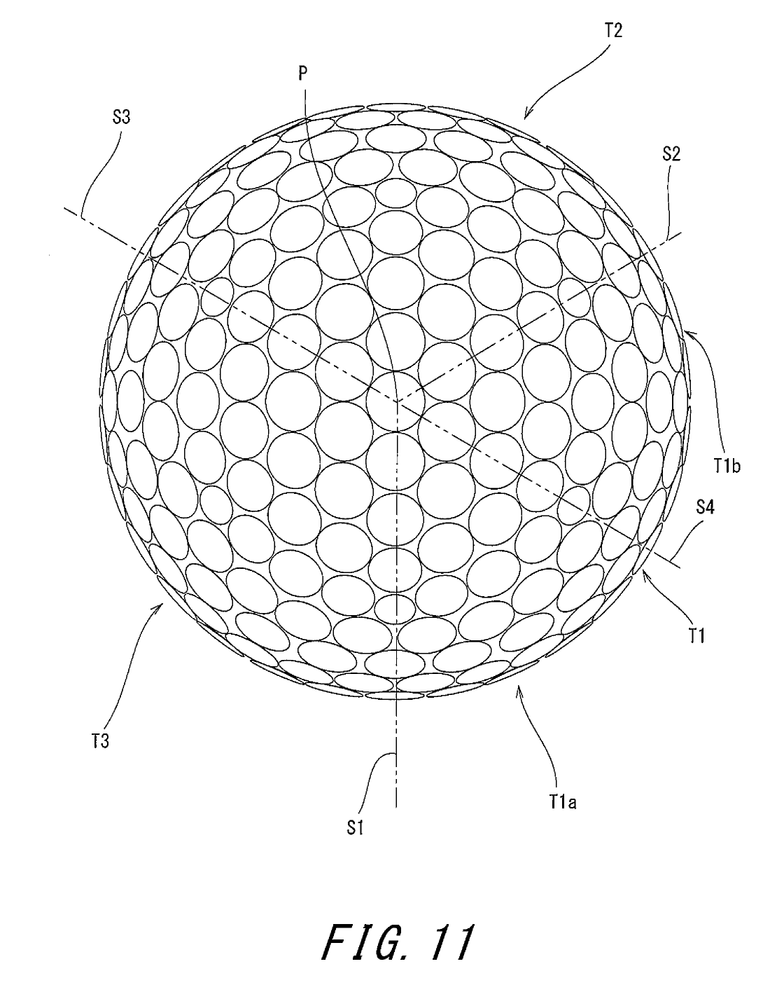

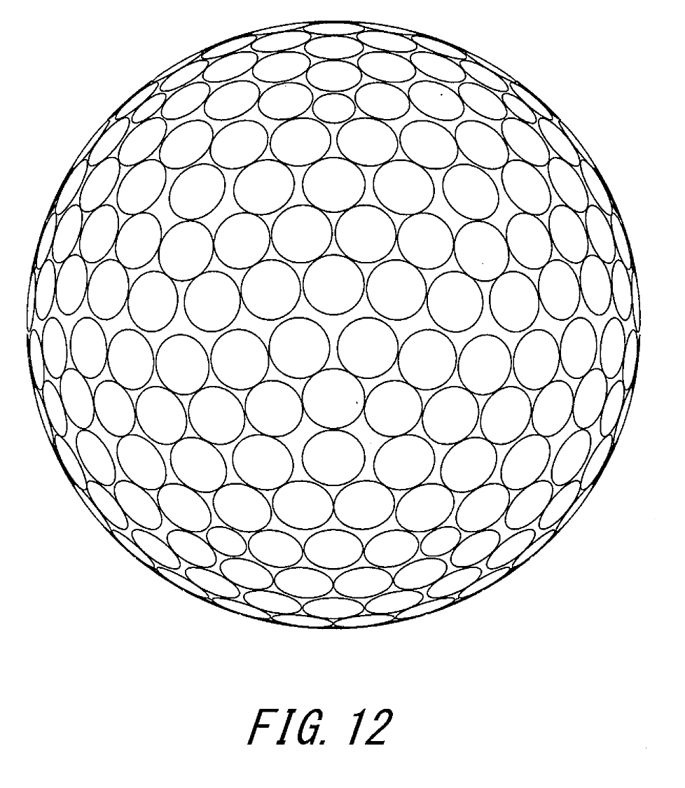

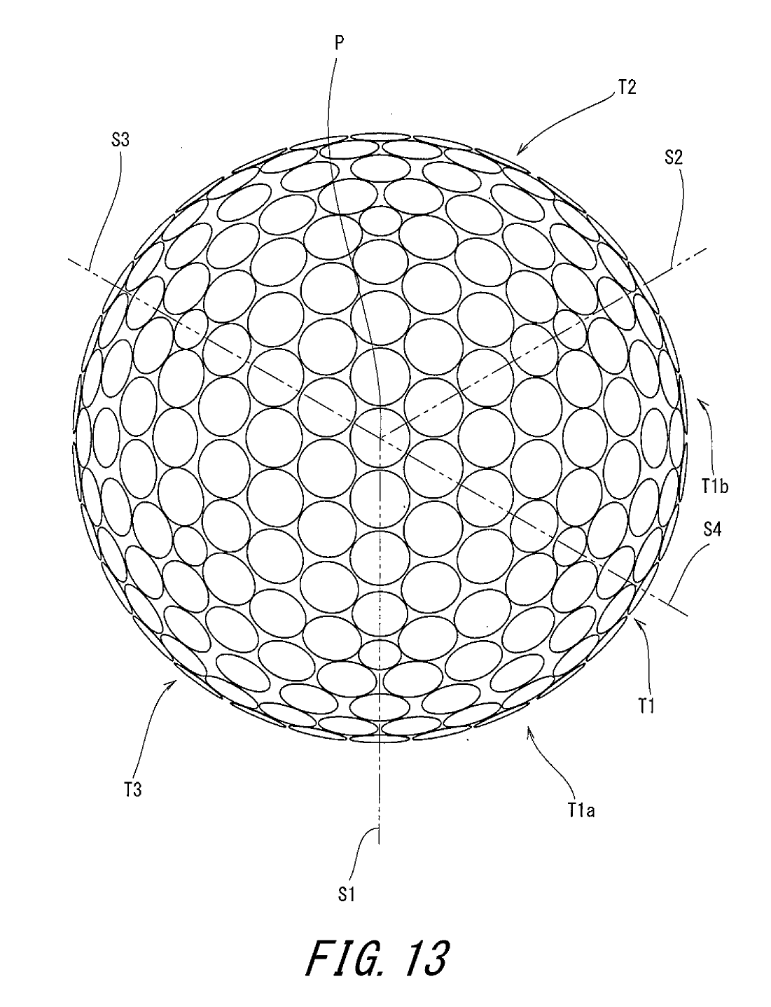

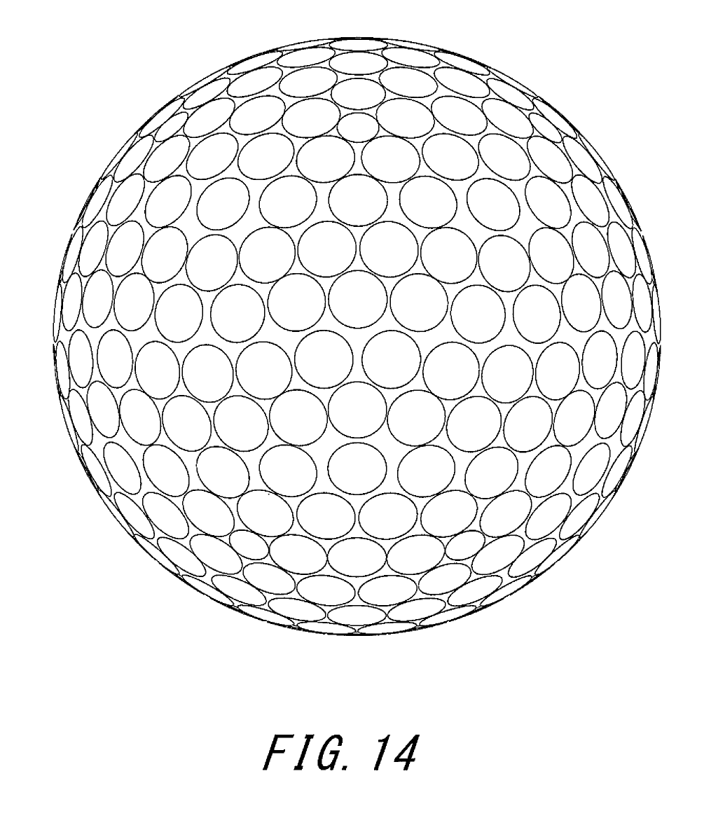

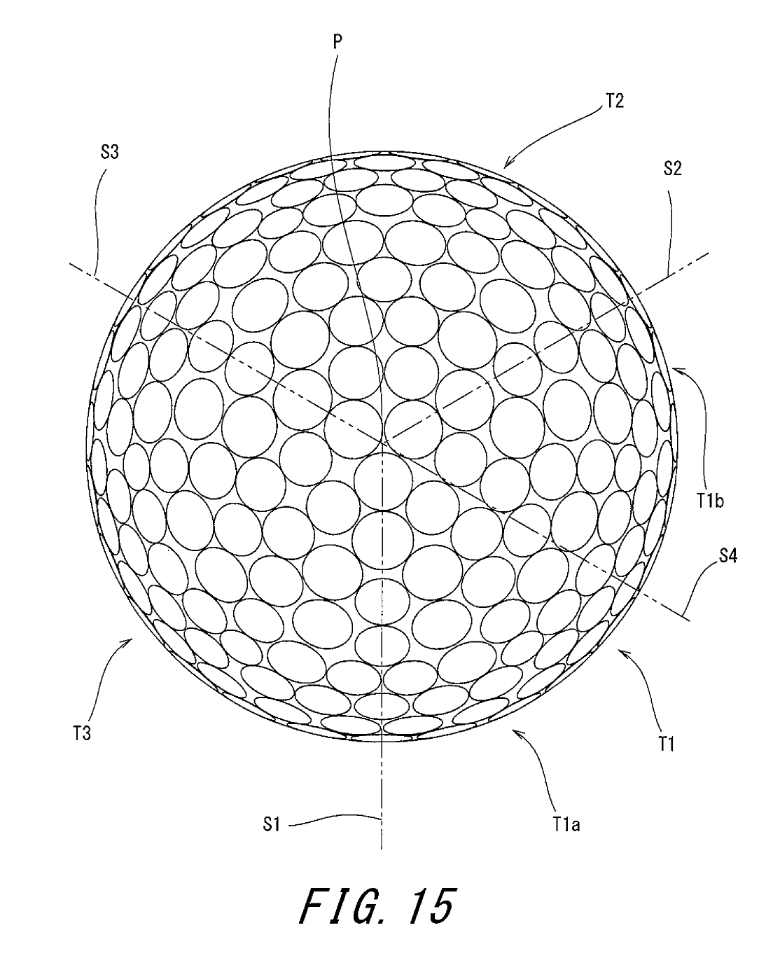

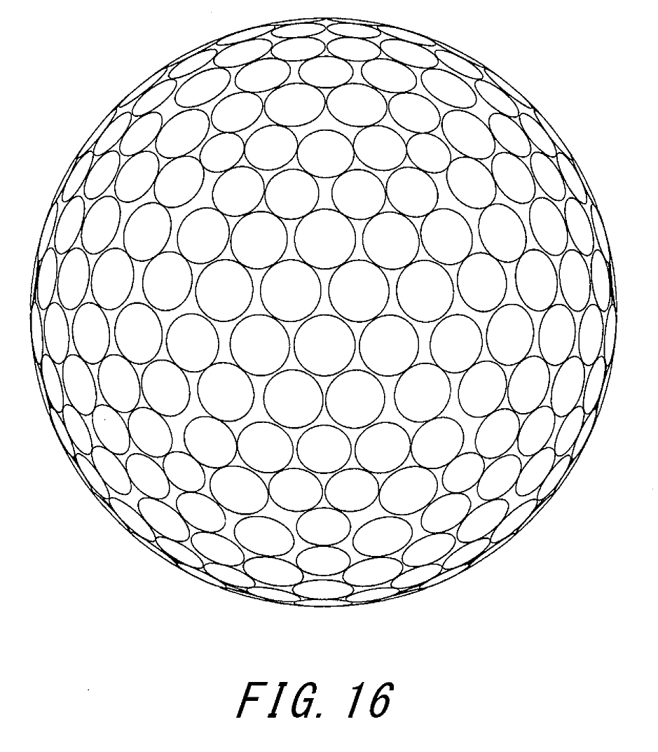

TABLE 5
Results of Evaluation

| | Ex. 1 | Ex. 2 | Ex. 3 | Ex. 4 |
|---|---|---|---|---|
| Core | I | I | I | I |
| Diameter (mm) | 40.10 | 40.10 | 40.10 | 40.10 |
| Ho (Shore C) | 63 | 63 | 63 | 63 |
| Hs (Shore C) | 82 | 82 | 82 | 82 |
| Mid layer | — | — | — | — |
| Cover | C1 | C1 | C1 | C1 |
| Thickness (mm) | 1.30 | 1.30 | 1.30 | 1.30 |
| Hardness (Shore C) | 85 | 85 | 85 | 85 |
| Hardness (Shore D) | 55 | 55 | 55 | 55 |
| Dimple | D1 | D2 | D3 | D4 |
| Plan view | FIG. 2 | FIG. 11 | FIG. 13 | FIG. 15 |
| Front view | FIG. 3 | FIG. 12 | FIG. 14 | FIG. 16 |
| Number of dimples | 338 | 338 | 338 | 330 |
| Number of units | 3 | 3 | 3 | 3 |
| Number of small | 6 | 6 | 6 | 6 |
| units | | | | |
| So (%) | 82.8 | 82 | 79.9 | 81.1 |
| TV (mm³) | 571.6 | 564.6 | 543.5 | 561.5 |
| Su of S (mm²) | 1.44 | 1.61 | 1.29 | 1.62 |
| Neighboring dimple | 1068 | 1068 | 1068 | 1014 |
| pairs | | | | |
| Average of L (mm) | 0.280 | 0.295 | 0.345 | 0.332 |
| Pd of L (mm) | 0.314 | 0.302 | 0.317 | 0.458 |
| Ball speed (m/s) | 58.6 | 58.6 | 58.6 | 58.6 |
| Launch angle (deg.) | 13.5 | 13.5 | 13.5 | 13.5 |
| Spin (rpm) | 2750 | 2750 | 2750 | 2750 |
| Flight distance (yd) | 201 | 200 | 200 | 199 |

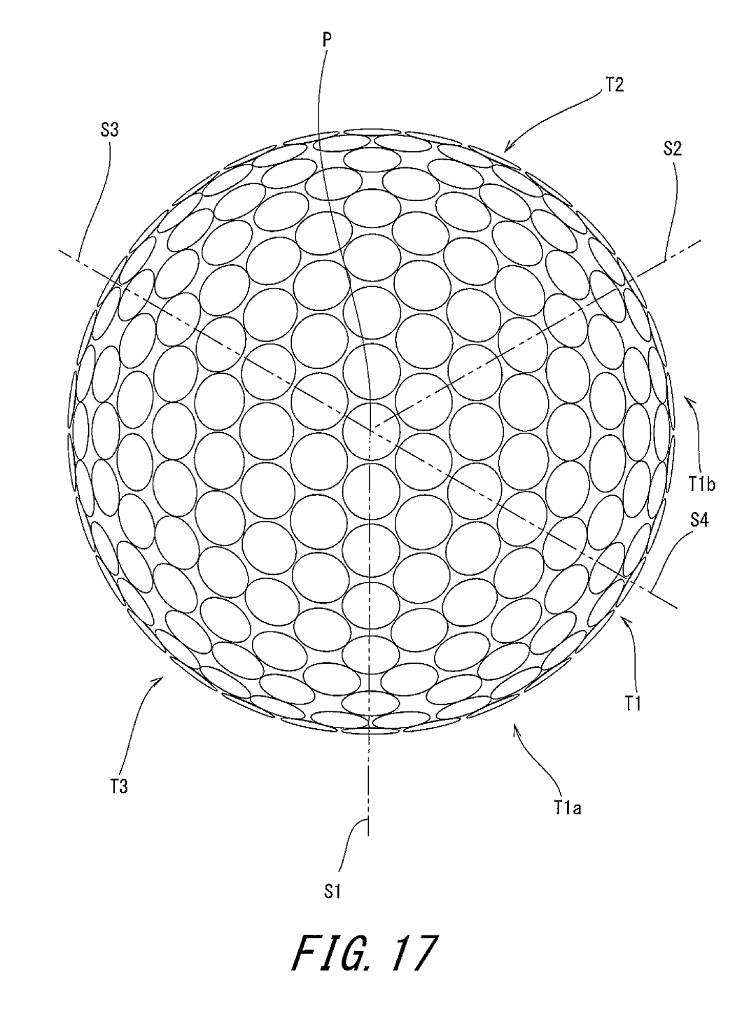

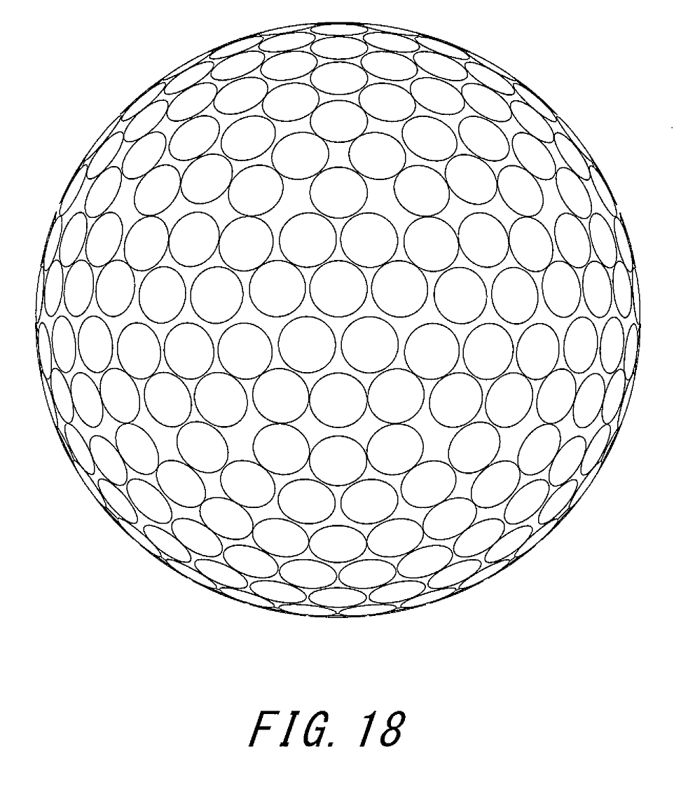

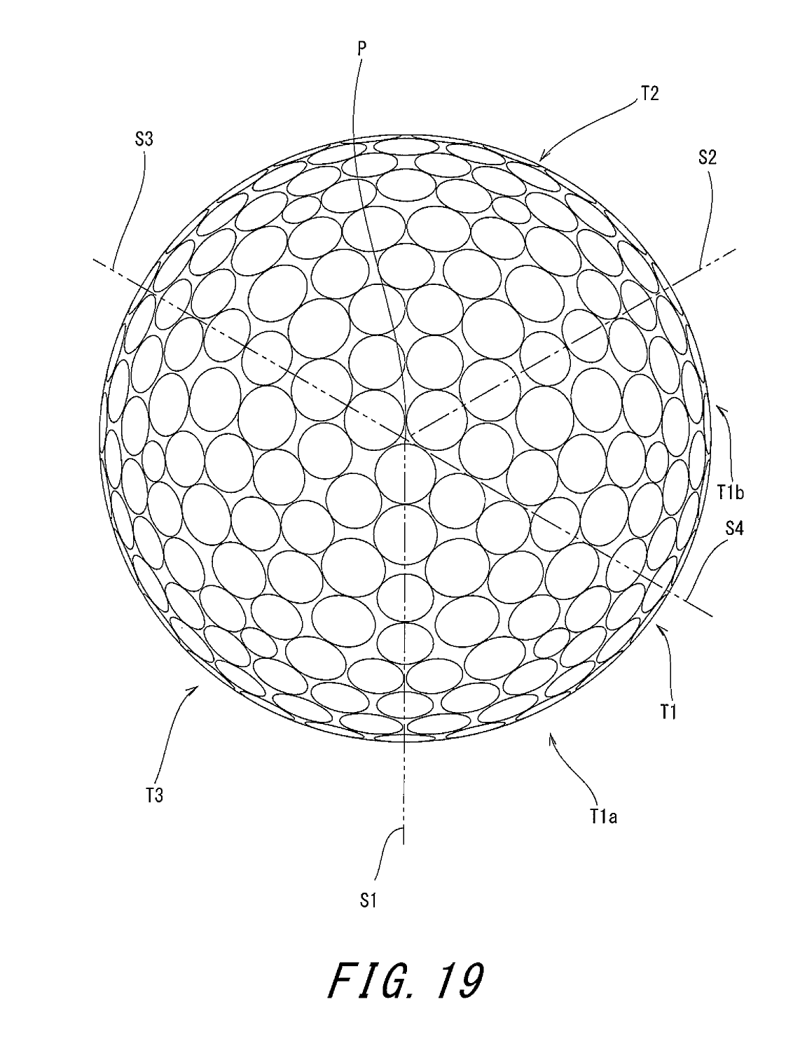

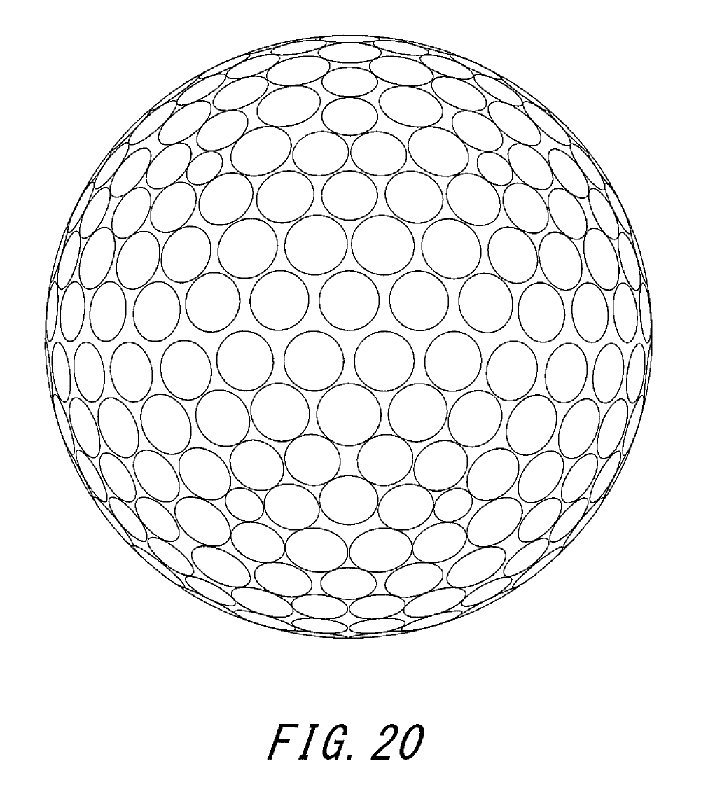

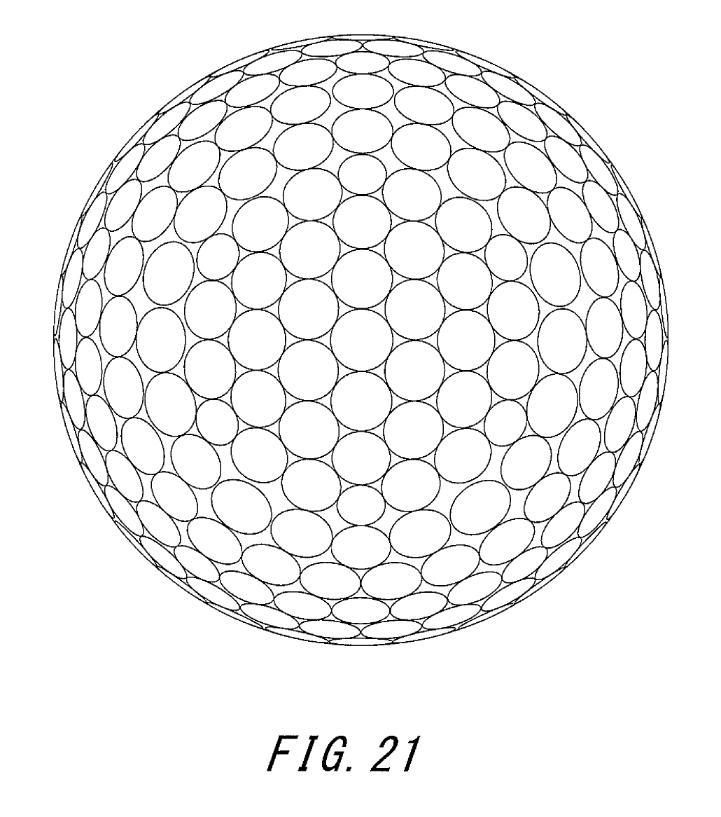

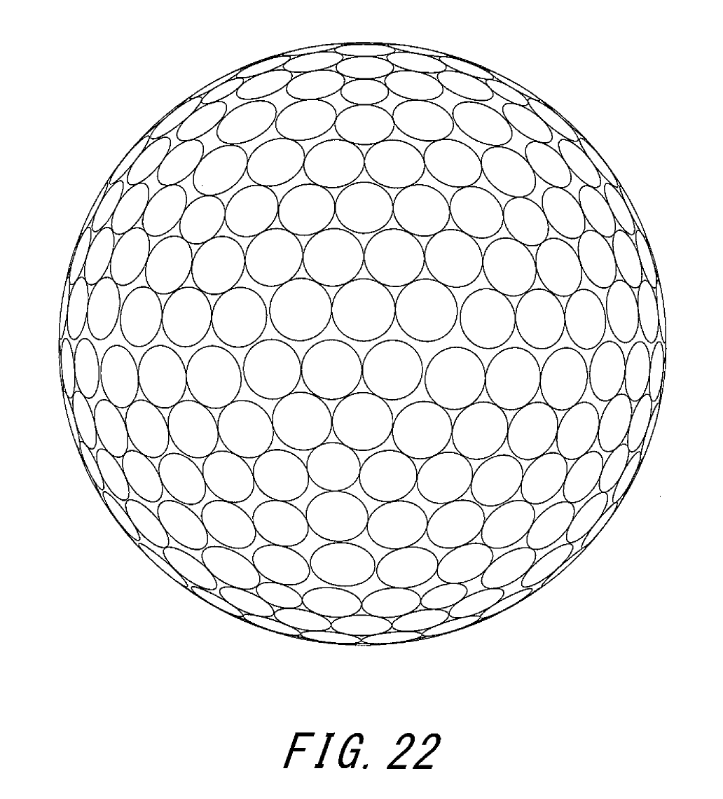

TABLE 6
Results of Evaluation

| | Comp. | Comp. | |
|---|---|---|---|
| | Ex. 1 | Ex. 2 | Ex. 5 |
| Core | I | I | I |
| Diameter (mm) | 40.10 | 40.10 | 40.10 |
| Ho (Shore C) | 63 | 63 | 63 |
| Hs (Shore C) | 82 | 82 | 82 |
| Mid layer | — | — | — |
| Cover | C1 | C1 | C1 |
| Thickness (mm) | 1.30 | 1.30 | 1.30 |
| Hardness (Shore C) | 85 | 85 | 85 |
| Hardness (Shore D) | 55 | 55 | 55 |
| Dimple | D5 | D6 | D7 |
| Plan view | FIG. 17 | FIG. 19 | FIG. 21 |
| Front view | FIG. 18 | FIG. 20 | FIG. 22 |
| Number of dimples | 338 | 330 | 344 |
| Number of units | 3 | 3 | — |
| Number of small | 6 | 6 | — |
| units | | | |
| So (%) | 78.1 | 79.9 | 85.3 |
| TV (mm³) | 490.1 | 529.3 | 592.5 |
| Su of S (mm²) | 0.00 | 2.10 | 1.42 |
| Neighboring dimple | 1068 | 1014 | 1038 |
| pairs | | | |
| Average of L (mm) | 0.434 | 0.375 | 0.190 |
| Pd of L (mm) | 0.502 | 0.452 | 0.306 |
| Ball speed (m/s) | 58.6 | 58.6 | 58.6 |
| Launch angle (deg.) | 13.5 | 13.5 | 13.5 |
| Spin (rpm) | 2750 | 2750 | 2750 |
| Flight distance (yd) | 193 | 194 | 198 |

TABLE 7
Results of Evaluation

| | Comp. | | | |
|---|---|---|---|---|
| | Ex. 3 | Ex. 6 | Ex. 7 | Ex. 8 |
| Core | I | I | I | I |
| Diameter (mm) | 40.10 | 40.10 | 40.10 | 40.10 |
| Ho (Shore C) | 63 | 63 | 63 | 63 |
| Hs (Shore C) | 82 | 82 | 82 | 82 |
| Mid layer | — | — | — | — |
| Cover | C4 | C3 | C2 | C5 |
| Thickness (mm) | 1.30 | 1.30 | 1.30 | 1.30 |
| Hardness (Shore C) | 76 | 80 | 83 | 91 |
| Hardness (Shore D) | 47 | 50 | 53 | 61 |
| Dimple | D1 | D1 | D1 | D1 |
| Plan view | FIG. 2 | FIG. 2 | FIG. 2 | FIG. 2 |
| Front view | FIG. 3 | FIG. 3 | FIG. 3 | FIG. 3 |
| Number of dimples | 338 | 338 | 338 | 338 |
| Number of units | 3 | 3 | 3 | 3 |
| Number of small | 6 | 6 | 6 | 6 |
| units | | | | |
| So (%) | 82.8 | 82.8 | 82.8 | 82.8 |
| TV (mm³) | 571.6 | 571.6 | 571.6 | 571.6 |
| Su of S (mm²) | 1.44 | 1.44 | 1.44 | 1.44 |
| Neighboring dimple | 1068 | 1068 | 1068 | 1068 |
| pairs | | | | |
| Average of L (mm) | 0.280 | 0.280 | 0.280 | 0.280 |
| Pd of L (mm) | 0.314 | 0.314 | 0.314 | 0.314 |
| Ball speed (m/s) | 58.2 | 58.4 | 58.5 | 58.9 |
| Launch angle (deg.) | 13.3 | 13.4 | 13.4 | 13.7 |
| Spin (rpm) | 2990 | 2900 | 2810 | 2570 |
| Flight distance (yd) | 196 | 198 | 200 | 205 |

TABLE 8
Results of Evaluation

| | Comp. | | |
|---|---|---|---|
| | Ex. 4 | Ex. 9 | Ex. 10 |
| Core | I | I | I |
| Diameter (mm) | 41.10 | 40.70 | 39.10 |
| Ho (Shore C) | 63 | 63 | 63 |
| Hs (Shore C) | 82 | 82 | 82 |
| Mid layer | — | — | — |
| Cover | C1 | C1 | C1 |
| Thickness (mm) | 0.80 | 1.00 | 1.80 |
| Hardness (Shore C) | 85 | 85 | 85 |
| Hardness (Shore D) | 55 | 55 | 55 |
| Dimple | D1 | D1 | D1 |
| Plan view | FIG. 2 | FIG. 2 | FIG. 2 |
| Front view | FIG. 3 | FIG. 3 | FIG. 3 |
| Number of dimples | 338 | 338 | 338 |
| Number of units | 3 | 3 | 3 |
| Number of small | 6 | 6 | 6 |
| units | | | |
| So (%) | 82.8 | 82.8 | 82.8 |
| TV (mm³) | 571.6 | 571.6 | 571.6 |
| Su of S (mm²) | 1.44 | 1.44 | 1.44 |
| Neighboring dimple | 1068 | 1068 | 1068 |
| pairs | | | |
| Average of L (mm) | 0.280 | 0.280 | 0.280 |
| Pd of L (mm) | 0.314 | 0.314 | 0.314 |
| Ball speed (m/s) | 58.5 | 58.5 | 58.7 |
| Launch angle (deg.) | 13.4 | 13.4 | 13.6 |
| Spin (rpm) | 3350 | 2960 | 2650 |
| Flight distance (yd) | 195 | 199 | 202 |

TABLE 9
Results of Evaluation

| | Ex. 11 | Ex. 12 |
|---|---|---|
| Core | I | I |
| Diameter (mm) | 38.70 | 38.10 |
| Ho (Shore C) | 63 | 63 |
| Hs (Shore C) | 82 | 82 |
| Mid layer | M1 | M1 |
| Thickness (mm) | 1.00 | 1.00 |
| Hardness (Shore C) | 63 | 63 |
| Hardness (Shore D) | 35 | 35 |
| Cover | C1 | C1 |
| Thickness (mm) | 1.00 | 1.30 |
| Hardness (Shore C) | 85 | 85 |
| Hardness (Shore D) | 55 | 55 |
| Dimple | D1 | D1 |
| Plan view | FIG. 2 | FIG. 2 |
| Front view | FIG. 3 | FIG. 3 |
| Number of dimples | 338 | 338 |
| Number of units | 3 | 3 |
| Number of small | 6 | 6 |
| units | | |
| So (%) | 82.8 | 82.8 |
| TV (mm³) | 571.6 | 571.6 |
| Su of S (mm²) | 1.44 | 1.44 |
| Neighboring dimple | 1068 | 1068 |
| pairs | | |
| Average of L (mm) | 0.280 | 0.280 |
| Pd of L (mm) | 0.314 | 0.314 |
| Ball speed (m/s) | 58.8 | 59.1 |
| Launch angle (deg.) | 13.5 | 13.7 |
| Spin (rpm) | 2720 | 2600 |
| Flight distance (yd) | 203 | 205 |

As shown in Tables 5 to 9, the golf ball of each Example has excellent flight performance. From the evaluation results, advantages of the present invention are clear.

The aforementioned dimple pattern is applicable to golf balls having various structures such as a four-piece golf ball, a five-piece golf ball, a six-piece golf ball, a thread-wound golf ball, and the like. The above descriptions are merely illustrative examples, and various modifications can be made without departing from the principles of the present invention.

What is claimed is:

1. A golf ball comprising a core and a cover positioned outside the core, wherein
the cover has a shore D hardness of not less than 50,
the cover has a thickness of not less than 1.00 mm,
the golf ball has a plurality of dimples on a surface thereof,
a standard deviation Su of areas of all the dimples is not greater than 1.7 mm², and
a standard deviation Pd of distances L between dimples of all neighboring dimple pairs is less than 0.500 mm.

2. The golf ball according to claim 1, wherein a ratio So of a sum of areas of the dimples relative to a surface area of a phantom sphere is not less than 78.0%.

3. The golf ball according to claim 1, wherein the standard deviation Su is not greater than 1.62 mm².

4. The golf ball according to claim 1, wherein the standard deviation Pd is not greater than 0.458 mm.

5. The golf ball according to claim 1, wherein
a dimple pattern of each hemisphere of a phantom sphere of the golf ball includes three units that are rotationally symmetrical to each other, and
a dimple pattern of each unit includes two small units that are mirror-symmetrical to each other.

6. The golf ball according to claim 1, wherein a sum of volumes of all the dimples is not less than 450 mm³ and not greater than 750 mm³.

7. The golf ball according to claim 1, wherein a total number of the dimples is not less than 250 and not greater than 390.

8. The golf ball according to claim 1, wherein the Shore D hardness of the cover is not less than 53.

9. The golf ball according to claim 1, wherein the thickness of the cover is not greater than 1.80 mm.
